(19) United States
(12) Patent Application Publication
(10) Pub. No.: US 2025/0056444 A1
(43) Pub. Date: Feb. 13, 2025

(54) TECHNIQUES FOR SIDELINK SYNCHRONIZATION

(71) Applicant: QUALCOMM Incorporated, San Diego, CA (US)

(72) Inventors: Sourjya DUTTA, San Diego, CA (US); Jae Ho RYU, San Diego, CA (US); Qing LI, Princeton Junction, NJ (US); Gabi SARKIS, San Diego, CA (US)

(21) Appl. No.: 18/749,429

(22) Filed: Jun. 20, 2024

Related U.S. Application Data
(60) Provisional application No. 63/518,867, filed on Aug. 10, 2023.

(51) Int. Cl. H04W 56/00; H04L 5/00

(52) U.S. Cl. CPC H04W 56/0015; H04L 5/001

(57) ABSTRACT

Methods, systems, and devices for wireless communication are described. A user equipment (UE) may receive an indication of a configuration, for synchronization of a communication link, of a plurality of component carriers (CCs) and respective priorities associated with the plurality of CCs and may receive a plurality of synchronization signals (SSs) via the plurality of CCs. The UE may synchronize with a timing source associated with a wireless device associated with a first CC of the plurality of CCs, and may transmit SSs via one or more of the plurality of CCs. The UE may select the first CC and may transmit the SSs via the one or more of the plurality of CCs based on the respective priorities associated with the plurality of CCs, respective received signal powers of the SSs, a synchronization source priority of the wireless device, one or more reference carriers, or any combination thereof.

### CROSS REFERENCE

The present application for patent claims the benefit of U.S. Provisional Patent Application No. 63/518,867 by DUTTA et al., entitled “TECHNIQUES FOR SIDELINK SYNCHRONIZATION,” filed Aug. 10, 2023, assigned to the assignee hereof, and expressly incorporated by reference herein.

### FIELD OF TECHNOLOGY

The following relates to wireless communication, including techniques for sidelink synchronization.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for sidelink synchronization. For example, the described techniques provide for enabling synchronization and backwards compatibility for carrier aggregation (CA) in sidelink. For example, a user equipment (UE) may receive an indication of a configuration for synchronization of a communication link, where the configuration may indicate one or more component carriers (CCs) and corresponding priorities for the synchronization via radio resource signaling (RRC), from one or more upper layers (e.g., service or application layers), or both. In some examples, the configuration may indicate a set of reference carriers that are prioritized (e.g., that may be associated with a highest possible per-carrier priority, for example, may be enabled). In some cases, a highest per-carrier priority may indicate that a CC is supported by both UEs supporting CA over sidelink communications and UEs not supporting CA over sidelink communications. The UE may receive one or more synchronization signals (SSs) from one or more wireless devices, where an SS may include one or more sequences, and may include system information. An SS may be communicated over a broadcast channel. The UE may also synchronize with one of the wireless devices corresponding to a timing source and a first CC of the one or more configured CCs based on the corresponding priorities, the SSs, or both. The UE may also transmit one or more SSs via a CC or multiple CCs of the one or more configured CCs based on the synchronizing and the priorities. In some examples, the UE may select the first CC and may transmit the one or more SSs via the one or multiple CCs based on respective per-carrier priorities, based on respective reference signal received powers (RSRPs) of the received SSs, based on synchronization source priorities of the one or more wireless devices, based on the one or more configured CCs including one or more reference carriers, or any combination thereof.

A method for wireless communication by a user equipment (UE) is described. The method may include receiving an indication of a configuration for synchronization of a communication link, where the configuration may indicate a set of multiple component carriers and respective priorities associated with the set of multiple component carriers for the synchronization, receiving a set of multiple synchronization signals via at least a subset of the set of multiple component carriers, and synchronizing with a wireless device associated with a first component carrier of the set of multiple component carriers, where the first component carrier of the set of multiple component carriers for the synchronizing with the wireless device is selected based on the respective priorities associated with the set of multiple component carriers.

A UE for wireless communications is described. The UE may include one or more memories storing processor executable code, and one or more processors coupled with the one or more memories. The one or more processors may individually or collectively operable to execute the code to cause the UE to receive an indication of a configuration for synchronization of a communication link, where the configuration may indicate a set of multiple component carriers and respective priorities associated with the set of multiple component carriers for the synchronization, receive a set of multiple synchronization signals via at least a subset of the set of multiple component carriers, and synchronize with a wireless device associated with a first component carrier of the set of multiple component carriers, where the first component carrier of the set of multiple component carriers for the synchronizing with the wireless device is selected based on the respective priorities associated with the set of multiple component carriers.

Another UE for wireless communications is described. The UE may include means for receiving an indication of a configuration for synchronization of a communication link, where the configuration may indicate a set of multiple component carriers and respective priorities associated with the set of multiple component carriers for the synchronization, means for receiving a set of multiple synchronization signals via at least a subset of the set of multiple component carriers, and means for synchronizing with a wireless device associated with a first component carrier of the set of multiple component carriers, where the first component carrier of the set of multiple component carriers for the synchronizing with the wireless device is selected based on the respective priorities associated with the set of multiple component carriers.

A non-transitory computer-readable medium storing code for wireless communications is described. The code may include instructions executable by a processor to receive an indication of a configuration for synchronization of a communication link, where the configuration may indicate a set of multiple component carriers and respective priorities associated with the set of multiple component carriers for the synchronization, receive a set of multiple synchronization signals via at least a subset of the set of multiple component carriers, and synchronize with a wireless device associated with a first component carrier of the set of multiple component carriers, where the first component carrier of the set of multiple component carriers for the synchronizing with the wireless device is selected based on the respective priorities associated with the set of multiple component carriers.

Some examples of the method, user equipment (UEs), and non-transitory computer-readable medium described herein may further include operations, features, means, or instructions for determining that a first subset of the set of multiple component carriers may be reference carriers and selecting the first component carrier from one or more of the first subset of the set of multiple component carriers having respective received signal powers satisfying a threshold received signal power.

Some examples of the method, user equipment (UEs), and non-transitory computer-readable medium described herein may further include operations, features, means, or instructions for selecting the first component carrier may be based on the wireless device being associated with a synchronization source priority that may be higher than or equal to synchronization source priorities associated with other wireless devices of the first subset of the set of multiple component carriers.

Some examples of the method, user equipment (UEs), and non-transitory computer-readable medium described herein may further include operations, features, means, or instructions for determining that two or more wireless devices of a set of multiple wireless devices transmitting synchronization signals over the first subset of the set of multiple component carriers may be associated with a highest synchronization source priority of respective synchronization source priorities associated with the set of multiple wireless devices, where synchronizing with the wireless device associated with the first component carrier may be based on a received signal power of a synchronization signal received over the first component carrier being greater than a second received signal power of a second synchronization signal received via a second component carrier associated with a second wireless device of the two or more wireless devices.

In some examples of the method, user equipment (UEs), and non-transitory computer-readable medium described herein, the first subset of the set of multiple component carriers may be determined based on the respective priorities associated with the first subset of the set of multiple component carriers being a highest priority value of a set of priority values.

In some examples of the method, user equipment (UEs), and non-transitory computer-readable medium described herein, the first component carrier may be selected based on a respective priority corresponding to the first component carrier indicating that the first component carrier is enabled for the synchronization, where each of the respective priorities may indicate whether a respective component carrier of the set of multiple component carriers is enabled or disabled for the synchronization.

Some examples of the method, user equipment (UEs), and non-transitory computer-readable medium described herein may further include operations, features, means, or instructions for determining that a first subset of the set of multiple component carriers may be reference carriers and selecting the first component carrier from the set of multiple component carriers based on the first subset of the set of multiple component carriers having respective received signal powers failing to satisfy a threshold received signal power.

Some examples of the method, user equipment (UEs), and non-transitory computer-readable medium described herein may further include operations, features, means, or instructions for determining that the wireless device may have a highest synchronization source priority among a set of multiple wireless devices transmitting synchronization signals over the set of multiple component carriers for which respective received signal powers satisfy the threshold received signal power.

In some examples of the method, user equipment (UEs), and non-transitory computer-readable medium described herein, the wireless device includes a second UE.

In some examples of the method, user equipment (UEs), and non-transitory computer-readable medium described herein, the indication of the configuration may be indicated by one or more applications, one or more services, or both.

In some examples of the method, user equipment (UEs), and non-transitory computer-readable medium described herein, the indication of the configuration may be received via a radio resource control message.

A method for wireless communication by a UE is described. The method may include receiving an indication of a configuration for synchronization of a communication link, where the configuration may indicate a set of multiple component carriers and respective priorities associated with the set of multiple component carriers for the synchronization, synchronizing with a timing source, and transmitting synchronization signals via one or more of the set of multiple component carriers based on the synchronizing with the timing source and the respective priorities associated with the set of multiple component carriers.

A UE for wireless communications is described. The UE may include one or more memories storing processor executable code, and one or more processors coupled with the one or more memories. The one or more processors may individually or collectively operable to execute the code to cause the UE to receive an indication of a configuration for synchronization of a communication link, where the configuration may indicate a set of multiple component carriers and respective priorities associated with the set of multiple component carriers for the synchronization, synchronize with a timing source, and transmit synchronization signals via one or more of the set of multiple component carriers based on the synchronizing with the timing source and the respective priorities associated with the set of multiple component carriers.

Another UE for wireless communications is described. The UE may include means for receiving an indication of a configuration for synchronization of a communication link, where the configuration may indicate a set of multiple component carriers and respective priorities associated with the set of multiple component carriers for the synchronization, means for synchronizing with a timing source, and means for transmitting synchronization signals via one or more of the set of multiple component carriers based on the synchronizing with the timing source and the respective priorities associated with the set of multiple component carriers.

A non-transitory computer-readable medium storing code for wireless communications is described. The code may include instructions executable by a processor to receive an indication of a configuration for synchronization of a communication link, where the configuration may indicate a set of multiple component carriers and respective priorities associated with the set of multiple component carriers for the synchronization, synchronize with a timing source, and transmit synchronization signals via one or more of the set of multiple component carriers based on the synchronizing with the timing source and the respective priorities associated with the set of multiple component carriers.

In some examples of the method, user equipment (UEs), and non-transitory computer-readable medium described herein, transmitting synchronization signals via one or more of the set of multiple component carriers may include operations, features, means, or instructions for transmitting synchronization signals via each of the set of multiple component carriers based on a capability of the UE.

In some examples of the method, user equipment (UEs), and non-transitory computer-readable medium described herein, transmitting synchronization signals via one or more of the set of multiple component carriers may include operations, features, means, or instructions for transmitting synchronization signals via a first component carrier of the set of multiple component carriers based on a first wireless device of the first component carrier being associated with a lowest synchronization source priority of respective synchronization source priorities associated with a set of multiple wireless devices associated with the set of multiple component carriers and based on a capability of the UE.

In some examples of the method, user equipment (UEs), and non-transitory computer-readable medium described herein, transmitting synchronization signals via one or more of the set of multiple component carriers may include operations, features, means, or instructions for transmitting synchronization signals via a first component carrier of the set of multiple component carriers based on a received signal power of a synchronization signal received via the first component carrier being less than a received signal power of a second synchronization signal received via a second component carrier of the set of multiple component carriers and based on a capability of the UE.

In some examples of the method, user equipment (UEs), and non-transitory computer-readable medium described herein, transmitting synchronization signals via one or more of the set of multiple component carriers may include operations, features, means, or instructions for transmitting synchronization signals via one or more component carriers of a first subset of the set of multiple component carriers based on received signal powers of respective synchronization signals received via the first subset of the set of multiple component carriers failing to satisfy a threshold received signal power, where the first subset of the set of multiple component carriers includes one or more reference carriers for synchronization.

In some examples of the method, user equipment (UEs), and non-transitory computer-readable medium described herein, transmitting synchronization signals via one or more of the set of multiple component carriers may include operations, features, means, or instructions for transmitting synchronization signals via one or more component carriers of a second subset of the set of multiple component carriers different from a first subset of the set of multiple component carriers based on received signal powers of respective synchronization signals received via the first subset of the set of multiple component carriers satisfying a threshold received signal power and based on received signal powers of respective synchronization signals received via the second subset of the set of multiple component carriers failing to satisfy the threshold received signal power, where the first subset of the set of multiple component carriers includes one or more reference carriers for synchronization.

In some examples of the method, user equipment (UEs), and non-transitory computer-readable medium described herein, respective priorities associated with the second subset of the set of multiple component carriers may be lower than a priority associated with the first subset of the set of multiple component carriers.

In some examples of the method, user equipment (UEs), and non-transitory computer-readable medium described herein, each of the respective priorities may indicate whether a respective component carrier of the set of multiple component carriers is enabled or disabled for the synchronization.

In some examples of the method, user equipment (UEs), and non-transitory computer-readable medium described herein, the timing source includes a wireless device associated with a first component carrier in a second subset of the set of multiple component carriers different from a first subset of the set of multiple component carriers including one or more reference carriers for synchronization and transmitting the synchronization signals via the one or more of the set of multiple component carriers may be based on one or more synchronization signals received via the first component carrier, the second subset of the set of multiple component carriers being associated with a priority different from a highest priority of the respective priorities, or both.

Some examples of the method, user equipment (UEs), and non-transitory computer-readable medium described herein may further include operations, features, means, or instructions for synchronizing with a second timing source, receiving one or more synchronization signals via a first subset of the set of multiple component carriers, and refraining from transmitting one or more additional synchronization signals via one or more of the set of multiple component carriers based on synchronizing with the second timing source and based on the first subset of the set of multiple component carriers including one or more reference carriers for synchronization, the first subset of the set of multiple component carriers being associated with a highest priority of the respective priorities, or both.

In some examples of the method, user equipment (UEs), and non-transitory computer-readable medium described herein, transmitting synchronization signals via one or more of the set of multiple component carriers may include operations, features, means, or instructions for transmitting synchronization signals via a first component carrier of the set of multiple component carriers, where the first component carrier may be selected from the set of multiple component carriers based on a capability of the UE, a synchronization source priority associated with a wireless device of the timing source, a received signal power associated with a synchronization signal received via the first component carrier, a random selection, or any combination thereof.

In some examples of the method, user equipment (UEs), and non-transitory computer-readable medium described herein, the timing source includes a network entity, a Global Navigation Satellite System (GNSS), or a second UE.

In some examples of the method, user equipment (UEs), and non-transitory computer-readable medium described herein, the timing source includes a wireless device associated with a first component carrier in a second subset of the set of multiple component carriers that may be different from a first subset of the set of multiple component carriers, the first subset of the set of multiple component carriers includes reference carriers for synchronization, and the UE receives a synchronization signal via the first component carrier during a first time duration associated with a first timer and transmits, subsequent to expiry of the first timer, the synchronization signals during a second time duration associated with a second timer.

In some examples of the method, user equipment (UEs), and non-transitory computer-readable medium described herein, the indication of the configuration may be indicated by one or more applications, one or more services, or both.

In some examples of the method, user equipment (UEs), and non-transitory computer-readable medium described herein, the indication of the configuration may be received via a radio resource control message.

### BRIEF DESCRIPTION OF THE DRAWINGS

FIG. 1 shows an example of a wireless communications system that supports techniques for sidelink synchronization in accordance with one or more aspects of the present disclosure.

FIGS. 2A and 2B show examples of a subframe diagram and a resource diagram that support techniques for sidelink synchronization in accordance with one or more aspects of the present disclosure.

FIG. 3 shows an example of a subframe diagram that supports techniques for sidelink synchronization in accordance with one or more aspects of the present disclosure.

FIG. 4 shows an example of a wireless communications system that supports techniques for sidelink synchronization in accordance with one or more aspects of the present disclosure.

FIG. 5 shows an example of a signaling diagram that supports techniques for sidelink synchronization in accordance with one or more aspects of the present disclosure.

FIGS. 6 and 7 show examples of process flows that supports techniques for sidelink synchronization in accordance with one or more aspects of the present disclosure.

FIGS. 8 and 9 show block diagrams of devices that support techniques for sidelink synchronization in accordance with one or more aspects of the present disclosure.

FIG. 10 shows a block diagram of a communications manager that supports techniques for sidelink synchronization in accordance with one or more aspects of the present disclosure.

FIG. 11 shows a diagram of a system including a device that supports techniques for sidelink synchronization in accordance with one or more aspects of the present disclosure.

FIGS. 12 through 17 show flowcharts illustrating methods that support techniques for sidelink synchronization in accordance with one or more aspects of the present disclosure.

### DETAILED DESCRIPTION

User equipments (UEs) and other devices in wireless communications systems may support carrier aggregation (CA), which may allow devices to communicate efficiently using multiple component carriers (CCs). In some cases, CA may be supported between UEs and other devices in sidelink communications. Some UEs may also support synchronization with a synchronization source, where synchronizing with a synchronization source may involve aligning time resources for communications (e.g., receptions, transmissions, monitoring) over one or more carriers of the UE with time resources of communications over the same carriers of the synchronization source. For example, the UE may receive one or more SSs from a synchronization source, and based on the SSs, may synchronize communications of the UE with communications of the synchronization source. However, one or more sidelink UEs may not be synchronized while using sidelink CA, which may lead to a loss of transmissions resulting in decreased reliability. Further, while some UEs may support CA in sidelink, other UEs may not. Thus, if a first UE is synchronized based receiving an SS transmitted via a carrier that is not supported by a second UE, the UEs may be unable to communicate, resulting in further loss of communications between UEs and decreased reliability.

Techniques described herein may enable backwards compatibility and synchronization between one or more sidelink devices in CA. For example, a UE may receive a configuration indicating whether one or more CCs are supported by UEs supporting CA for sidelink communications, UEs not supporting CA for sidelink communications, or both, via a per-carrier priority (e.g., SLSyncPriorityPerCarrier). The configuration may also indicate whether one or more CCs are configured as reference carriers (e.g., preferred carriers selected for use in synchronization), where in some examples, a reference carrier may be backwards compatible (e.g., supported by both CA-supporting UEs and UEs not supporting CA for sidelink communications). The UE may receive the configuration from upper layers (e.g., application layers, service layers via sidelink) or via an RRC configuration. In some examples, a UE may determine a synchronization source based on the configuration and one or more synchronization signals (SSs) received at the UE, where an SS may include one or more sequences and system information (e.g., received over a broadcast channel). For example, when the UE does not have a network entity (e.g., gNB) or Global Navigation Satellite System (GNSS) as a synchronization source, the UE may select a source associated with a configured reference carrier on which an SS is received (e.g., from a synchronization reference UE) based on a highest synchronization source priority, a highest reference signal received power (RSRP) of one or more SSs, or both. If the UE is not configured with reference carriers (or if RSRPs of SSs received via the reference carriers are below an RSRP threshold), the UE may determine a set of CCs of the configuration with a highest per-carrier priority, and, within the set, may select a CC based on a highest associated synchronization source priority or RSRP value.

The UE may similarly transmit one or more SSs based on per-carrier priority, synchronization source priority, RSRP values, or any combination thereof. For example, if the UE has a network entity/GNSS as a synchronization source and is configured with one or more reference carriers, the UE may transmit SSs via a subset of one or more of the reference carriers on which an RSRP of a broadcast channel of one or more received signals (e.g., the SSs) is less than a threshold. If the UE supports multiple CC transmission (e.g., simultaneous transmission over multiple CCs for CA), the UE may transmit SSs on all CCs of the subset. Otherwise, the UE may transmit on a CC on which an SS was received that is associated with a lowest synchronization source priority, a lowest RSRP, or both. If all reference carriers meet an RSRP threshold, the UE may instead transmit synchronization signals on one or more CCs associated with a next highest per-carrier priority and on which SSs are received under the RSRP threshold. By way of another example, if the UE has a reference UE as a sync source, the UE may refrain from transmitting SSs at all if the UE receives one or more synchronization signals via one or more reference carriers or one or more carriers with a highest per-carrier priority, and otherwise may become a synchronization source for other devices.

In some examples, by prioritizing reference carriers that are associated with backwards compatibility, or by instead selecting non-reference carriers that support backwards compatibility when possible, the UE 115-a may prioritize carriers that are supported by a greater quantity of UEs, thus improving reliability of communications and synchronization between UEs that support CA for sidelink communications and UEs that do not support CA, among other UEs. Further, by performing synchronization, the UE may improve a reliability of communications. Further, by prioritizing reference carriers and carriers with highest per-carrier priority when transmitting on one CC, or by transmitting on all reference CCs of a subset, the UE 115-a may similarly transmit SSs to a greater quantity of UEs. Additionally, or alternatively, by selecting a CC with a lowest associated RSRP or lowest synchronization source priority for transmitting SSs, the UE 115-a may reduce interference with other transmissions and received signals.

Aspects of the disclosure are initially described in the context of wireless communications systems. Aspects of the disclosure are further illustrated by and described with reference to subframe diagrams, resource diagrams, wireless communications systems, signaling diagrams, and process flows that relate to techniques for sidelink synchronization. Aspects of the disclosure are further illustrated by and described with reference to apparatus diagrams, system diagrams, and flowcharts that relate to techniques for sidelink synchronization.

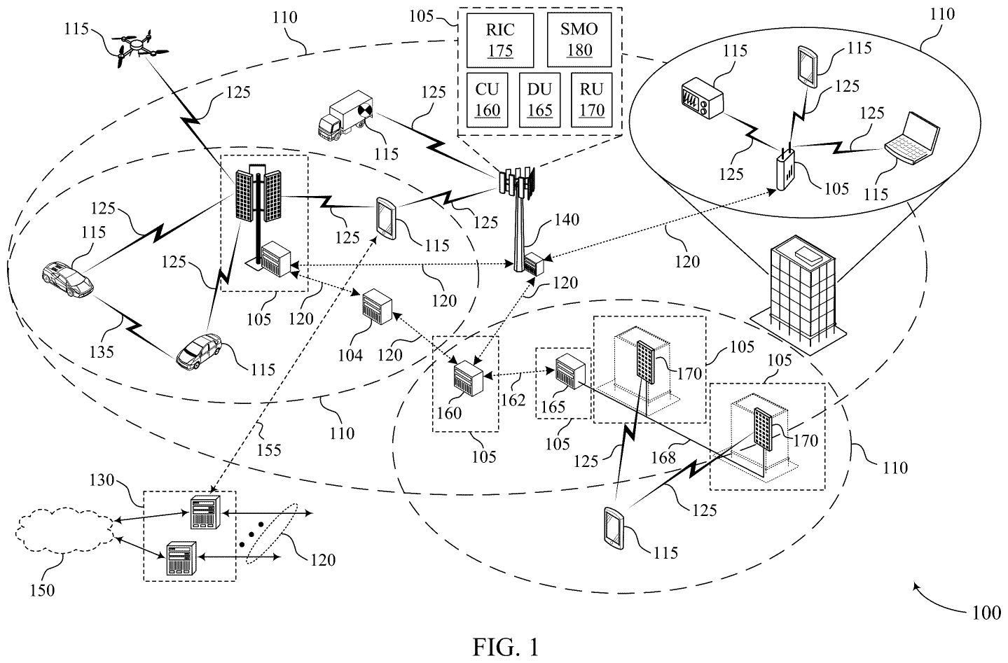

FIG. 1 shows an example of a wireless communications system 100 that supports techniques for sidelink synchronization in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for sidelink synchronization as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., SSs, system information), control signaling that coordinates operation for the carrier, user data, or other signaling. The wireless communications system 100 may support communication with a UE 115 using CA or multi-carrier operation. A UE 115 may be configured with multiple downlink CCs and one or more uplink CCs according to a CA configuration. CA may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a CA configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a CA configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, the wireless communications system 100 may support transmission or reception of one or more sidelink SSs for synchronization. For example, one or more UEs 115 or other devices may exchange sidelink SSs using one or more CCs. In some examples, devices of the wireless communications system 100 may support synchronization with a synchronization source, where synchronizing with a synchronization source may involve aligning time resources for communications (e.g., receptions, transmissions, monitoring) over one or more carriers of the UE with time resources of communications over the same carriers of the synchronization source. For example, a UE 115 may receive one or more SSs from a synchronization source, such as a network entity 105, a reference UE 115, and based on the SSs, may synchronize communications of the UE 115 with communications of the synchronization source. Additionally, or alternatively, the UE may use other synchronization sources such as a GNSS. In some cases, UEs 115 may support CA in sidelink. However, one or more sidelink UEs 115 or other devices may not be synchronized while using sidelink CA, which may lead to a loss of transmissions resulting in decreased reliability. Further, while some UEs 115 may support CA in sidelink, other UEs 115 may not, which may further increase a loss of communications between UEs 115.

Techniques described herein may enable backwards compatibility and synchronization between one or more sidelink devices in CA. For example, a UE 115 may receive a configuration (e.g., from an upper layer, a network entity 105 via RRC, or both) indicating whether one or more CCs are supported by UEs supporting CA, UEs not supporting CA, or both. For example, the configuration may indicate a per-carrier priority (e.g., indicated by a SLSyncPriorityPerCarrier parameter or indicated as enabled or disabled for the synchronization, such as by a slss-TxDisabled parameter, where a respective value of a parameter may be indicated for each CC), as well as may indicate whether one or more CCs are configured as reference carriers. In some examples, a UE may determine and synchronize with a synchronization source (e.g., align time resources for one or more communications), and may communicate based on the synchronization, based on the configuration and one or more SSs received at the UE, as well as based on synchronization source priorities of one or more synchronization sources, RSRP values for the one or more SSs received at the UE, or any combination thereof. Similarly, the UE may transmit one or more SSs based on per-carrier priorities, synchronization source priorities, RSRP values, or any combination thereof.

In some examples, a UE 115 may be configured (e.g., by a network entity 105) via RRC with a slss-TxDisabled parameter, which, if set for a CC, may disable the UE from transmitting sidelink SS in the CC. For example, slss-TxDisabled=TRUE may indicate that a corresponding CC, even though equipped with synchronization resources, may not be used as a synchronization carrier frequency to transmit sidelink SSs, physical sidelink broadcast channel (PSBCH) messages, and the like. However, the UE 115 may transmit SSs on one or more carriers that have slss-TxDisabled set to FALSE. The UE 115 may also use an RSRP associated with a received sidelink SS to determine whether or not to transmit on that CC. For example, when an RSRP associated with a sidelink SS received on a corresponding CC is less than a threshold (e.g., preconfigured at the UE 115), and if slss-TxDisabled=FALSE for that CC, the UE 115 may transmit on that CC.

Additionally, or alternatively, the UE 115 may be configured via RRC with a slss-TxMultiFreq parameter indicating whether transmission of sidelink SSs is enabled on multiple carrier frequencies (e.g., for sidelink SS transmission over aggregated carriers in CA). For example, slss-TxMultiFreq=TRUE may indicate that the UE 115 may transmit sidelink SSs on multiple carrier frequencies for V2X sidelink communication. In some examples, when slss-TxMultiFreq=TRUE, a sidelink UE 115 may transmit sidelink SSs on more than one (e.g., up to all) component carriers configured at the UE 115. If this field is absent, or set to FALSE, the UE 115 may transmit sidelink SSs on a single synchronization carrier frequency, where the synchronization carrier frequency may be a CC over which the sidelink UE 115 receives synchronization information.

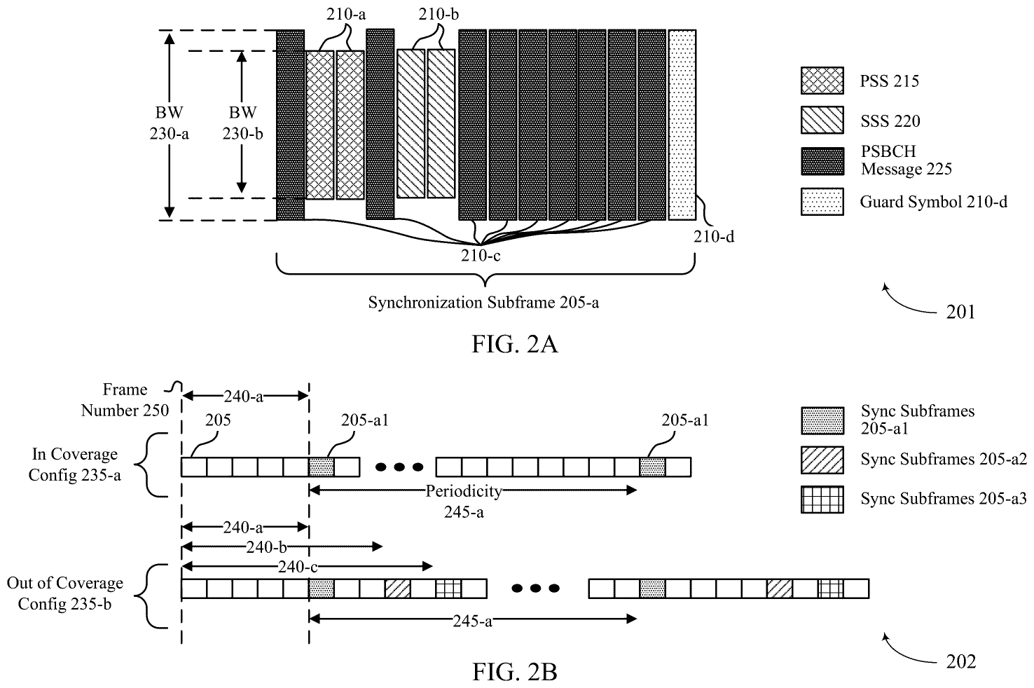

FIGS. 2A and 2B show examples of a subframe diagram 201 and a resource diagram 202 that support techniques for sidelink synchronization in accordance with one or more aspects of the present disclosure. The subframe diagram 201 and the resource diagram 202 may implement or be implemented to realize aspects of the wireless communications system 100. For example, the subframe diagram 201 and the resource diagram 202 may represent timing for transmissions between one or more network entities 105 and UEs 115 as described with reference to FIG. 1. In some examples, the subframe diagram 201 and the resource diagram 202 may represent a subframe diagram and a resource diagram supported by long-term evolution (LTE) devices.

In FIG. 2A, the subframe diagram 201 may include a synchronization subframe 205-a in sidelink, which may be an example of a subframe 205 including one or more symbols 210 in time (e.g., each symbol 210 defined over one or more ms in the time domain) for transmission of signals for synchronization in sidelink communications. The subframe diagram 201 may illustrate time resources for a bandwidth (BW) 230-a (e.g., a subset of subcarriers such as the center six (6) PRBs) of a sidelink channel). For example, the synchronization subframe 205 may include one or more symbols 210-a for transmission of a primary synchronization signal (PSS) in sidelink (e.g., 2 sidelink PSS symbols), as well as one or more symbols 210-b for transmission of a secondary synchronization signal (SSS) in sidelink (e.g., 2 sidelink SSS symbols) for the subset of subcarriers. The synchronization subframe 205-a may additionally include one or more symbols 210-c for transmission of a PSBCH message 225 (e.g., nine (9) PSBCH symbols). The PSBCH may include pilots for channel measurement, such as one or more pilot symbols associated with estimation of parameters of the channel, as well as control information, such as sidelink system information or acknowledgement information, in one or more of the symbols 210-c (e.g., three (3) DMRS symbols), as well as data. The synchronization subframe 205 may additionally include a guard symbol 210-d.

In some examples, the BW 230-a may correspond to a BW of a channel allocated for the PSBCH symbols 210-c and the guard symbols 210-d, and a BW 230-b for the sidelink PSS symbols 210-a and the sidelink SSS symbols 210-b may be a subset of the BW 230-a. For example, the synchronization subframe 205-a may include a total of 72 subcarriers for the BW 230-a for PSBCH transmission, and 62 subcarriers for the BW 230-b for sidelink PSS and sidelink SSS transmission. The sidelink channel may include other subcarriers outside of BW 230-a and BW 230-b, and signals (e.g., DMRS) and channels (e.g., PSCCH, PSSCH) may be allocated within regions of the channel BW not included in BW 230-a or BW 230-b.

In FIG. 2B, the resource diagram 202 may represent time resources configured (e.g., via RRC) for sidelink communications, including one or more subframes 205 of one or more frames over time for transmission between one or more UEs 115 or other devices. The subframes 205 may include one or more synchronization subframes 205-a, which may include one or more symbols for synchronization as described with respect to FIG. 2A (e.g., resources within the one or more symbols used for synchronization such as the BW 230-a or the BW 230-b).

For example, when in-coverage (e.g., within a cell or coverage area 110 of a network entity 105), a UE 115 may be configured with an in-coverage configuration 235-a (e.g., by the network entity 105). In some examples, a resource may be configured for the in-coverage configuration 235-a. For example, the UE 115 may receive (e.g., based on monitoring for) a signal from a network entity 105 including an indicator synchOffsetIndicator indicating an offset 240-a for a time location of the start of a synchronization subframe 205-a1. In some examples, the indicator synchOffsetIndicator may be the same as a value synchOffsetIndicator-1 that may be pre-configured at the UE 115 (e.g., via RRC). In some examples, synchronization subframes 205-a1 may also be defined by a periodicity 245-a for transmissions (e.g., 160 ms). Thus, the synchronization subframe 205-a1 may be repeated according to the periodicity 245-a. In some examples, the UE 115 may determine the start of a first synchronization subframe based on the offset indicator (e.g., based on a frame number 250 such as a direct frame number (DFN) or SFN), and may base further synchronization subframes on the periodicity 245-a and the offset indicator.

When outside of coverage of the network entity 105 (e.g., not within a cell or coverage area 110), the UE 115 may be configured with an out-of-coverage configuration 235-b. One or more resources for synchronization may be configured for the out-of-coverage configuration 235-b. For example, the UE 115 may be configured with a syncOffsetIndicator-1 similar to in the in coverage configuration 235-a defining the offset 240-a and be configured with the periodicity 245-a. Additionally, or alternatively, the UE 115 may be configured with a syncOffsetIndicator-2 defining an offset 240-b for a time location of a synchronization subframe 205-a2, and a syncOffsetIndicator-3 defining an offset 240-c for a time location of a synchronization subframe 205-a3, where the synchronization subframes 205-a1, 205-a2, and 205-a3 may repeat according to the periodicity 245-a. In some examples, synchronization procedures may differ depending on whether syncOffsetIndicator-3 is configured or not. The synchronization subframes 205-a1, 205-a2, and 205-a3 may each be defined by the same subframe diagram 201 as illustrated in FIG. 2A.

In some examples, a source for synchronization of the UE 115 may be a network entity (e.g., gNB, eNB), a GNSS, or a synchronization reference UE (e.g., a SyncRef UE). For example, a network entity, GNSS, or synchronization reference UE may transmit one or more SSs, PSBCHs, among other signaling, using synchronization subframes 205-a according to the resource diagram 202. In some examples, synchronization reference UEs may perform synchronization for another UE by synchronizing directly with a network entity or GNSS (e.g., using 1 hop) or indirectly (e.g., greater than 1 hop), or may be independent synchronization sources for other UEs 115.

In some examples, the subframe diagram 201 and the resource diagram 202 may support backwards compatibility and additional techniques for further synchronization in sidelink CA. For example, a wireless device may select a synchronization source for synchronization based on one or more reference carriers that are supported by both UEs that support CA for sidelink communications, as well as UEs that do not support CA for sidelink communications, or based on a per-carrier priority of one or more CCs, which may in some examples prioritize enabled carriers, or prioritize a highest per-carrier priority indicating support for backwards compatibility. By thus selecting backwards compatible carriers, the wireless device may select carriers that are supported by a greater quantity of UEs, including UEs that communicate according to sidelink resources as shown in FIGS. 2A and 2B. This may result in an increase in successful transmissions in sidelink due to a greater quantity of UEs communicating on supported CCs, due to UEs being synchronized on same CCs, or both, which may improve a reliability of communications.

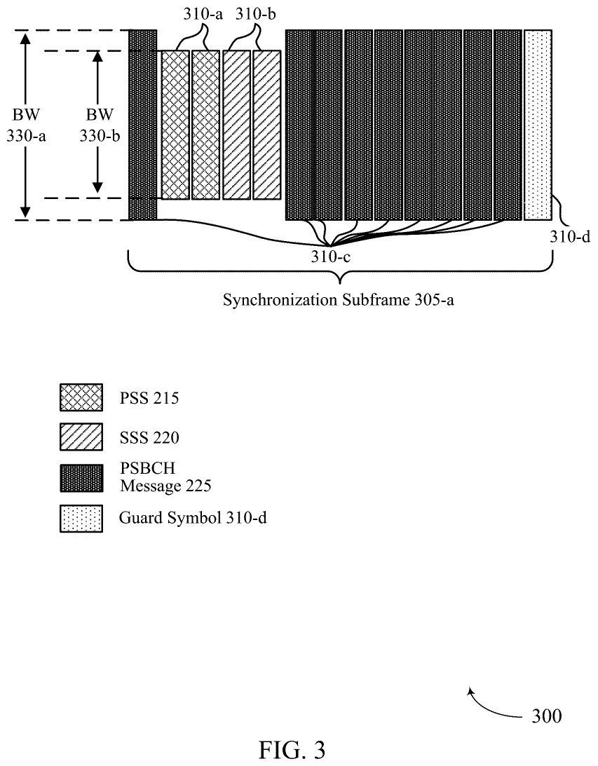

FIG. 3 shows an example of a subframe diagram 300 that supports techniques for sidelink synchronization in accordance with one or more aspects of the present disclosure. The subframe diagram 300 may implement or be implemented to realize aspects of the wireless communications system 100, the subframe diagram 201, and the resource diagram 202. For example, the subframe diagram 300 may represent timing for transmissions between one or more network entities 105, UEs 115, and other devices as described with reference to the subframe diagram 201. In some examples, the subframe diagram 300 may represent a subframe diagram supported by devices that support CA in sidelink and devices that do not support CA in sidelink (e.g., UEs 115), where the devices may use one or more synchronization procedures as described in FIGS. 2A and 2B. In some examples, the subframe diagram 300 may represent a subframe diagram and a resource diagram supported by NR devices.

For example, the subframe diagram 300 may include a synchronization subframe 305-a in sidelink including one or more symbols 310, which may be an example of the synchronization subframe 205-a. For example, the synchronization subframe 305-a may include one or more sidelink PSS symbols 310-a for a sidelink PSS 215, one or more sidelink SSS symbols 310-b for a sidelink SSS 220, one or more PSBCH symbols 310-c for a PSBCH message 225, and a guard symbol 310-d at the end of the synchronization subframe 305-a. The subframe diagram 201 may illustrate time resources for a BW 330-a (e.g., a subset of subcarriers such as the center eleven (11) PRBs) of a sidelink channel). In some examples, the BW 330-a may correspond to a BW of a channel allocated for the PSBCH symbols 310-c and the guard symbol 310-d and a BW 330-b for the sidelink PSS symbols 310-a and the sidelink SSS symbols 310-b may be a subset of the BW 330-a (e.g., 127 subcarriers). The sidelink channel may include other subcarriers outside of BW 330-a and BW 330-b, and signals (e.g., DMRS) and channels (e.g., PSCCH, PSSCH) may be allocated within regions of the channel BW not included in BW 330-a or BW 330-b.

The synchronization subframe 305-a may similarly be used for in coverage and out of coverage scenarios and repeated based on a periodicity with synchronization resource locations defined by synchronization offsets (e.g., SynchOffsetIndicator). In some examples, the sidelink subframe 305-a may represent a sidelink synchronization signal block (SSB) including a PSBCH, DMRSs in the PSBCH, PSSs, SSSs, etc. In some examples, PSS and SSS may be reused for Uu communications in NR.

In some examples, the PSS symbols 310-a and the SSS symbols 310-b including SSs may be in a different location of the synchronization subframe 305-a as illustrated in FIG. 3 compared to in the synchronization subframe 205-a of FIG. 2A. In some examples, PSSs and SSSs may be based on Zadoff Chu sequences, or may be based on m-sequences. Further, a fixed mapping of a synchronization subframe 205 or 305 may be used, or UEs may receive one or more messages configuring the start RB of a synchronization subframe 305-a (e.g., via RRC from a gNB). In some examples, a UE 115 may support simultaneous transmission and simultaneous reception on aggregated carriers, for example, by receiving SSs simultaneously on one or more aggregated carriers, or transmitting simultaneously using one or more aggregated carriers (e.g., may operate in multiple aggregated carriers in half-duplex). Additionally, or alternatively, UEs 115 may support full-duplex operations.

In other examples, a UE 115 (or other device) may utilize similar synchronization procedures. For example, a UE 115 may have sidelink SS IDs based on synchronization reference signal selection. That is, sidelink SS IDs in a sidelink SSB may determine the priority of a synchronization source from which the synchronization is derived. In an example, a transmitting UE 115 (or other device) may determine a sidelink SS ID based on a synchronization source from which timing is derived. For example, a gNB may use a first range of SS IDs, and a reference UE may use a second range of SS IDs. In an example, a gNB may be of a higher synchronization source priority (and a higher priority class) than a GNSS in a band (e.g., intra-band CA), or vice versa, where gNBs and GNSSs are of a higher priority than synchronization reference UEs. A receiving UE 115 or other device may then decode the sidelink SS ID value from a received SSB including a PSBCH and related information in a synchronization subframe (e.g., the synchronization subframe 305-a), and based on the ID and which range the ID falls in and information of the PSBCH, the receiving device may determine a corresponding synchronization source priority, or priority class, of the corresponding synchronization source. Similarly, synchronization sources may include a network entity (e.g., gNB for in coverage scenarios), or a GNSS or synchronization reference UE (e.g., for out of coverage scenarios). Each synchronization source type may thus be associated with a synchronization source priority, as well as a SL-SS ID range mapped to a synchronization source priority class.

Thus, a UE 115 may select a synchronization source based on the synchronization source priority (e.g., a sl-sync-priority parameter) in a band. For example, if a reliable gNB or GNSS source is available, the UE 115 may select a gNB or a GNSS based on which has a higher synchronization source priority value, and may use the selected synchronization source for synchronizing. Otherwise, the UE may use a synchronization reference UE (e.g., SyncRef UE may have a lower priority class). In some examples, if the UE 115 receives multiple synchronization signals (e.g., SL-SSBs, PSBCH received in a synchronization subframe after monitoring) indicating multiple synchronization sources with a same synchronization source priority, the UE 115 may select a synchronization source based on an SS associated with a highest RSRP value. For example, when receiving multiple SL-SSBs indicating IDs of multiple gNBs, the UE 115 may select a synchronization source based on a highest RSRP value of a corresponding SL-SSB, a respective PSBCH, or both.

In some examples, the subframe diagram 300 may support backwards compatibility and additional techniques for further synchronization in sidelink CA. For example, UEs 115 operating on multiple aggregated carriers and supporting CA and the subframe diagram 300 for sidelink SS communications may also support one or more backwards compatible CCs that are supported by other UEs 115 that may lack support for CA in sidelink. UEs 115 supporting CA may also support communications with UEs that do not support CA in sidelink for services supported by the non-CA-supporting UEs. For example, a CA-supporting UE may both select synchronization carriers for synchronizing with a source based on whether such services are supported on that carrier, and may transmit SL SSs based on whether the services are supported for that carrier. In an example, UEs supporting CA and using the subframe diagram 300 may support selection of CCs based on one or more reference carriers (e.g., that are supported by both UEs supporting CA and UEs not supporting CA in sidelink), or based on a per-carrier priority of one or more CCs, which may in some examples prioritize enabled carriers, or prioritize a highest per-carrier priority indicating support for backwards compatibility. Thus, the CA-supporting UEs may also synchronize with the other UEs operating in such carriers so that all CCs are aligned in time to enable backwards compatible communication.

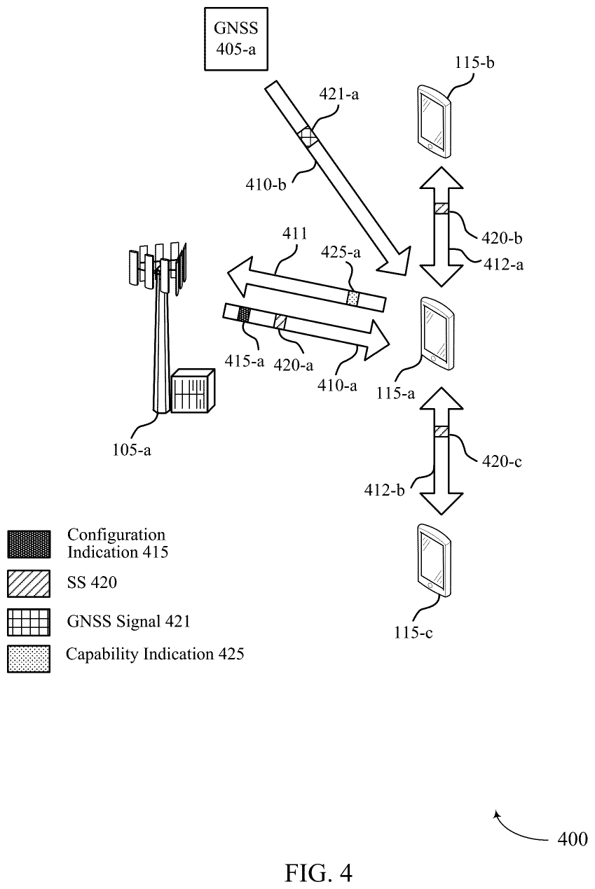

FIG. 4 shows an example of a wireless communications system 400 that supports techniques for sidelink synchronization in accordance with one or more aspects of the present disclosure. The wireless communications system 400 may implement or be implemented to realize aspects of the wireless communications system 100, the subframe diagram 201, the resource diagram 202, and the subframe diagram 300. For example, the wireless communications system 400 may include a network entity 105-a, a GNSS 405-a, a UE 115-a, a UE 115-b, and a UE 115-c, which may represent network entities 105, GNSSs, and UEs 115 described with respect to FIGS. 1-3. The UE 115-a may include a downlink communication link 410-a and an uplink communication link 411 with the network entity 105-a (e.g., a Uu link), a downlink communication link 410-b with the GNSS 405-a, or both. The UE 115-a may also include a sidelink communication link 412-a with the UE 115-b, and a sidelink communication link 412-b with the UE 115-c. In some examples, the UE 115-a, the UE 115-b, and the UE 115-c may transmit one or more capability messages 425 indicating capability of a UE (e.g., support for CA or single CC transmission or reception) in uplink or sidelink, including a capability message 425-a transmitted by the UE 115-a. In some examples, the network entity 105-a, the GNSS 405-a, and the UEs 115-a, 115-b, and 115-c may support techniques enabling backwards compatibility in sidelink CA as described herein.

For example, the UE 115-a may receive an indication 415 of a configuration including one or more CCs and respective priorities which may be associated with synchronization of one or more devices (e.g., between UEs 115, network entities 105, other network nodes or wireless devices). For example, the UE 115-a may receive an indication 415-a from a network entity 105-a, which may represent an RRC message for configuring (e.g., preconfiguring) the UE 115-a. The indication 415-a may indicate a list of resources, such as CCs and time resources including subframes and synchronization subframes, which the UE 115-a may use for one or more communications in sidelink, uplink, downlink, or any combination thereof. The indication 415-a may include an indication of a per-carrier priority for each respective CC, which may be associated with synchronization of one or more devices. In some examples, the per-carrier priority may be represented by a parameter, such as a SLSyncPriorityPerCarrier parameter, or by slss-TxDisabled. In some cases, any of SLSyncPriorityPerCarrier, slss-TxDisabled, or another parameter, may include two values (e.g., to indicate enabled or disabled for synchronization, to indicate backwards compatibility). In one example, a value of SLSyncPriorityPerCarrier=1 may indicate a CC supporting UEs that do not support CA in sidelink, while a value of SLSync PriorityPerCarrier=0 may indicate that a carrier is supported by CA-supporting UEs, but not by UEs that do not support CA. In another example, the parameter SLSync PriorityPerCarrier may include a range of values that may be determined based on support of UEs that do not support CA for a respective carrier, as well as class(es) or types of traffic supported on the carriers. Additionally, or alternatively, the indication 415-a may indicate additional parameters, including slss-TxMultiFreq as described herein.

Additionally, or alternatively, the UE 115-a may receive an indication 415 from one or more applications or services of an application layer or a service layer, respectively. That is, an upper layer, such as an application or service layer at the UE 115-a, may indicate the indication 415-a to the PHY layer of the UE 115-a. The indication 415-a may be used to indicate one or more parameters for PHY level (Layer 1) and Layer 2 (e.g., MAC, RLC) communication at the UE 115-a. For example, the indication 415-a may indicate whether a CC of a list of CCs is for a Layer 2 destination ID (e.g., a sidelink broadcast or groupcast communication for one or more V2X services, such as between the UE 115-a and the UE 115-b or the UE 115-c), and whether the CC may be supported by UEs that do not support CA.

Additionally, or alternatively, the indication 415-a may indicate a list of reference carriers. A reference carrier may represent a CC that is given priority in SS transmission and for synchronizing procedures (e.g., time alignment), where a reference carrier may in some examples be backwards compatible. For example, a reference carrier may be supported by both CA-supporting UEs and UEs that do not support CA, and in some cases may be associated with a highest per-carrier priority. Additionally, or alternatively, the indication 415-a may indicate, for each CC of a list of CCs, whether a CC is to be used as a reference carrier for CA-capable UEs (e.g., supporting intra-band CA) for a Layer 2 destination ID (e.g., for a same sidelink broadcast or groupcast communication for one or more V2X services as described herein). In some examples, the UE 115-a may determine a set of reference carriers from the indication 415-a.

In some examples, the UE 115-a may support synchronization and transmission using a single reference carrier. For example, the UE 115-a may be configured with a single reference carrier in an indication 415, such as the indication 415-a (e.g., if a carrier is indicated as a single reference carrier, via a priority enabling a single carrier, such as a respective value of slss-TxDisabled disabling each carrier except the reference carrier). In some examples, if an indication 415 includes the single reference carrier, the UE 115-a may disable SS transmission, synchronization, or both, on any other aggregated CCs if the UE 115-a supports CA, where the UE 115-a may perform synchronization, SS transmission, or both, using the configured reference carrier and an associated synchronization source, which may be an example of a timing source, or a device associated with a timing source.

In some examples, if the UE does not have the network entity 105-a or the GNSS 405-a as a synchronization source, the UE 115-a may use a sidelink synchronization reference UE 115 associated with the reference carrier as a synchronization source reference. For example, the UE 115-a may determine (e.g., select) a synchronization reference UE associated with the reference carrier based on a synchronization source priority, a PSBCH RSRP, or both of the reference carrier source priorities and RSRPs of other reference carriers associated with other reference UEs. In an example, the UE 115-a may receive multiple SSBs from the UE 115-b and one or more other UEs 115 or other devices, and may select a synchronization source based on which of the SSBs is associated with a higher priority synchronization source, or based on which of the PSBCHs of the SSBs has a higher RSRP. In some examples, for SS transmission, the UE 115-a may determine that an RSRP of a signal received over the configured synchronization CC is below a threshold RSRP (γ₂), and may transmit one or more SSs 420 over the configured reference CC based on the RSRP being below the threshold. For example, the UE 115-a may transmit an SS 420-c to the UE 115-c and may act as a synchronization reference UE for the UE 115-c. Otherwise, the UE 115-a may refrain from transmitting SSs over the configured reference carrier(s).

By way of another example, the UE 115-a may support synchronization using multiple CCs and determining a UE synchronization source for multi-carrier synchronization transmissions. In an example, the UE 115-a may not have the network entity 105-a nor the GNSS 405-a as a synchronization source, in some cases based on the network entity 105-a or the GNSS 405-a being blocked by geography, not receiving any SSs 420 from the network entity 105-a or GNSS signals 421 from the GNSS 405-a, or based on SSs from the network entity 105-a having an RSRP below a threshold. In such an example, a single reference carrier may be determined or configured, where the UE may receive a sidelink SSB (e.g., from a synchronization reference UE) over a single reference carrier. In such a case, if an associated PSBCH has an RSRP greater than a threshold (γ₁) on the reference carrier, the UE 115-a may use a wireless device associated with the reference carrier as a synchronization source. Additionally, or alternatively, if the UE 115-a has multiple reference carriers determined or configured, the UE 115-a may select a sidelink SSB on a reference carrier with a highest synchronization source priority and a highest PSBCH RSRP within a set of synchronization sources with a highest synchronization source priority. For example, the UE 115-a may compare one or more SSs 420 transmitted by the network entity 105-a, the UE 115-b, other devices, or any combination thereof. In an example, the UE 115-a may compare source priorities and RSRPs of an SS 420-c and an SS 420-b (or a GNSS signal 421-a), and select a corresponding source based on highest source priorities and a highest RSRP. In such an example, a highest RSRP may be selected if greater than the threshold γ₁. In some cases, the threshold γ₁ may allow the UE 115-a to have a sufficient signal strength with a selected synchronization source for synchronizing communications.

In some examples, if an RSRP of a PSBCH of each configured reference carriers is below the threshold (γ₁), or if reference carriers are not configured at the UE 115-a, the UE 115-a may select a source associated with another CC for synchronization. For example, the UE may determine a set of one or more CCs with a highest per-carrier priority if configured with per-carrier priorities (e.g., via the indication 415-a). Within this set of carriers, the UE 115-a may determine a subset of CCs with a highest synchronization source priority. For example, the UE 115-a may determine a synchronization source priority of one or more sources associated with one or more received SSBs based on a sidelink SS ID, or based on master information block (MIB) information. If one CC is found with a highest source priority, the UE 115-a may use this CC and a corresponding source as a synchronization source. If more than one CC are found with a same highest synchronization source priority, the UE 115-a may select a CC with a highest corresponding RSRP. For example, within a subset of CCs with a highest source priority, the UE 115-a may select a CC with a highest PSBCH RSRP that is also above the threshold γ₁. In some examples, if no CC of the highest synchronization source priority meets the threshold, the UE 115-a may select a next highest synchronization source priority, and may compare RSRPs if multiple CCs are configured, and may continue this process for each synchronization source priority until a CC is selected.

In some cases, if the UE 115-a is unable to determine a synchronization source from the set of CCs with a highest per-carrier priority, the UE 115-a may determine a CC associated with a highest synchronization source priority and highest RSRP above the RSRP threshold for a next highest per-carrier priority. In some cases, per-carrier priority may not be set (e.g., reference carriers may be determined based on upper layer indications from application/service layer without a configuration for per-carrier priority). In such an example, if the UE 115-a is configured with one or more reference carriers, the UE 115-a may select from the reference carriers as described herein. Otherwise, if the UE 115-a is not configured with one or more reference carriers, or RSRPs of one or more SSBs received from the one or more reference carriers is below the RSRP threshold, the UE 115-a my select a non-reference carrier based on synchronization source priority and highest RSRP value that is above the threshold as described herein, or selecting a next source priority for comparing RSRPs.

In some examples, after determining a synchronization source, the UE 115-a may perform a synchronization for one or more communications. For example, the UE 115-a may align timing resources (e.g., symbols, slots) of communications to be synchronized with communications of a selected synchronization source. For example, the SS 420-a received from the network entity 105-a or the SS 420-b received from the UE 115-b, or a GNSS signal 421-a received from the GNSS 405-a, may provide timing information that the UE 115-a may use to synchronize with a selected synchronization source. Once synchronization is complete, the UE 115-a may transmit and receive according to the synchronized timing resources.

By way of another example, the UE 115-a may support SS transmission using one or multiple CCs. For example, the UE may have a gNB or GNSS as a synchronization source (or another timing source that may be associated with a corresponding device) and may be configured with a set of reference carriers via an indication 415. The UE 115-a may determine that from the set of reference carriers, a first subset of reference carriers have a corresponding PSBCH RSRP less than a second RSRP threshold (γ₂) by determining an RSRP of one or more SSs 420, such as the SS 420-a and the SS 420-b. If the UE 115-a is capable of or configured to transmit sidelink SSs via multiple CCs, the UE 115-a may transmit one or more SSs on one or more carriers in the subset. For example, the UE 115-a may transmit the SS 420-c, which may be an SSB including a PSBCH, a PSS, an SSS, etc., via multiple CCs in CA. In an example, the UE 115-a may transmit the SS 420-c to the UE 115-c via one of the multiple CCs on which the UE 115-a transmits, where the UE 115-c may receive the CC, and where the CC may be a reference carrier supported by the UE 115-c (e.g., a UE not supporting CA in sidelink).

By way of another example, the UE 115-a may support sidelink CA but may transmit sidelink SSs 420 via one CC (e.g., may not support simultaneous transmission over multiple carriers at a same time). In one case, the UE 115-a may determine to transmit on a CC over which a lowest PSBCH RSRP was received, for example, for the SSs 420-a and 420-b. Additionally, or alternatively, the UE 115-a may determine to transmit in a CC over which a received sidelink SSB has a lowest synchronization source priority. By way of another example, the UE 115-a may determine a subset of CCs from the subset of reference CCs with RSRP less than the second threshold γ₂, where the second subset may include CCs over which SL SSB received has lowest synchronization source priority. From the second subset, the UE 115-a may transmit SSs on a CC over which the lowest PSBCH RSRP was received, and may similarly select next highest synchronization source priority and RSRP if not found.

In some examples, all reference carriers may meet the PSBCH RSRP criteria by being greater than the second threshold γ₂ (e.g., the first subset may be a null set). In such a case, the UE 115-a may determine a set of CCs with a next highest per-carrier priority, or SLSyncPriorityPerCarrier (e.g., if the reference carriers are configured with a highest SLSyncPriorityPerCarrier, or may select a highest per-carrier priority, where the reference carriers may or may not be associated with the per-carrier priority). From the set of CCs with the next highest per-carrier priority, the UE 115-a may determine a subset P among the set of CCs over which PSBCH is received with a RSRP less than the second threshold γ₂. If the UE is capable or configured to transmit sidelink SSs on multiple CCs, the UE may transmit one or more SSs 420 (e.g., sidelink SSB) via all carriers in the subset P. Otherwise, if the UE 115-a is capable or configured to transmit sidelink SSs on one CC (e.g., may not support simultaneous transmission or reception over multiple CCs in sidelink CA), the UE 115-a may similarly select a CC for transmission based on a lowest PSBCH RSRP, a lowest SSB synchronization source priority, or both within the subset P. If multiple CCs have a same RSRP or SSB or are above the threshold, the UE may select a CC based on a next highest RSRP and a next highest synchronization source priority within the subset P.

Thus, the UE 115-a may synchronize with priority given to synchronization sources associated with reference CCs and highest per-carrier priority CCs, as well as transmit by prioritizing reference carriers and carriers with highest per-carrier priority when transmitting on one carrier, or transmitting on all reference CCs of a subset. Such operations may enable the UE 115-a to prioritize backwards compatible CCs for both synchronization and SS transmission (or simply by transmitting on all backwards compatible CCs), which may improve stability and reliability of communications as well as synchronization between devices. Additionally, or alternatively, by selecting a CC for SS transmission based on a lowest associated RSRP or lowest synchronization source priority for received SSs, the UE 115-a may reduce interference with other transmission and received signals, further increasing reliability in communications.

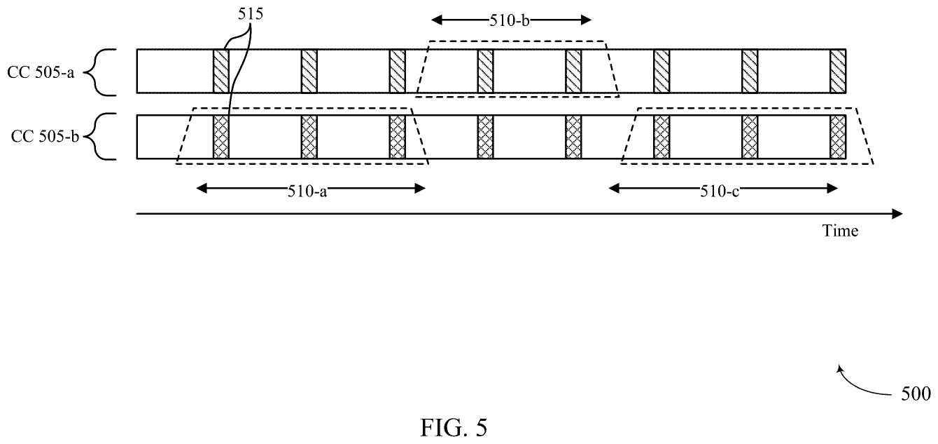

In some examples, the UE 115-a may have a synchronization reference UE as a synchronization source, such as the UE 115-b. In such an example, if the UE 115-a receives one or more SSs (e.g., SSBs) via one or more reference carriers, or via one or more carriers associated with a highest per-carrier priority (e.g., SLSyncPriorityPerCarrier=1 or another value indicating backwards compatibility), the UE 115-a may refrain from transmitting sidelink SSs within one or more sidelink SSBs, and may receive signaling via one or more sidelink SS opportunities (e.g., opportunities for sidelink SS transmission, reception, or both). By way of another example, if the UE 115-a receives SSs, such as synchronization reference SSBs, from the UE 115-b via one or more carriers that are not reference carriers, or via one or more carriers that are associated with a different per-carrier priority than the highest per-carrier priority, the UE 115-a may determine to become a synchronization source via one or more reference carriers or via one or more carriers associated with the highest per-carrier priority. For example, the UE 115-a may transmit one or more SSs including the SS 420-c to the UE 115-c, where the UE 115-c may use the UE 115-a as a synchronization reference UE, or as a synchronization source itself. In some examples, while being able to act as a synchronization reference UE or a synchronization source, the UE 115-a may switch between receiving and transmitting as described with reference to FIG. 5.

FIG. 5 shows an example of a signaling diagram 500 that supports techniques for sidelink synchronization in accordance with one or more aspects of the present disclosure. In some examples, the signaling diagram 500 may represent switching between receiving and transmitting of signaling for a UE 115 supporting SS transmission while acting as a reference UE.

For example, the signaling diagram 500 may represent signaling via one or more CCs 505 supported at a UE 115, such as the UE 115-a. Supported CCs may include a CC 505-a and a CC 505-b. In some cases, the CC 505-a may represent a reference CC, or a CC associated with a highest per-carrier priority. Additionally, or alternatively, the CC 505-a may represent another CC that is selected based on a highest synchronization source priority, a lowest RSRP, or one or more next highest synchronization source priorities or RSRPs as described herein.

In some examples, a UE 115 may switch between transmitting and receiving on different CCs. For example, the UE 115-a may determine, based on a configured timer (T₁), a duration (e.g., time period) 510-a over which the UE may receive signals via synchronization resources configured at the UE to synchronize with a synchronization carrier and corresponding timing source. For example, the UE may synchronize with a device associated with a timing source, where a timing source may be a timing of communications of the device via the carrier. A timing source may alternatively represent another source for timing synchronization that may or may not be associated with one specific device.

In an example, the UE 115 may receive one or more SSs (e.g., SSBs with PSBCH and PSS/SSS) during one or more sidelink SS opportunities (e.g., opportunities for sidelink SS reception or transmission) via the duration 510-a based on the timer T₁. On expiry of the timer, the UE may start a second timer (T₂) indicating duration 510-b on which the UE 115 may transmit sidelink SSs via one or more CCs selected using methods described herein. For example, if the UE 115-a has a synchronization reference UE as a synchronization source and does not receive SSs via one or more reference carriers or carriers of a highest per-carrier priority, the UE 115-a may transmit using one or more supported reference carriers, such as the CC 505-a, where the CC 505-a may be a reference carrier. Additionally, or alternatively, if the UE 115 is not configured with reference carriers (or does not support reference carriers) or if one or more reference carriers do not satisfy conditions for transmission (e.g., are associated with received SSs above the second RSRP threshold), the UE 115 may transmit using all supported CCs of a highest per-carrier priority via one or more sidelink SS opportunities 515, including via the CC 505-a, where the CC 505-a may be a non-reference carrier. In some examples, the UE 115 may revert to receiving SSs upon expiry of the second timer during a duration 510-c.

In some examples, if the UE is configured or capable to transmit sidelink SSs via a single CC for sidelink synchronization, the UE may select a CC based on a supported CC being a reference carrier (e.g., such as CC 505-a, where the CC 505-a may be a reference carrier), based on a highest per-carrier priority, based on a lowest synchronization source priority, based on a lowest RSRP received over the CC, etc. as discussed herein. For example, the UE 115 may have a reference UE as a synchronization source, and may choose the CC 505-a to transmit sidelink SSs over the duration 510-b based on the CC 505-a having a lowest synchronization source priority and a lowest PSBCH RSRP of one or more configured reference carriers, where the UE may receive one or more SSs during the duration 510-a on the CC 505-a and other reference carriers. Additionally, or alternatively, the UE may select the CC 505-a (e.g., a non-reference carrier) for transmission of SSs from a set of non-reference carriers upon which SSs are received based on the CC 505-a having a higher per-carrier priority or a lowest synchronization source priority and a lowest PSBCH RSRP. In another case, the UE may randomly choose a CC to transmit sidelink SS, and may reselect this CC after the expiry of a 3rd timer Tᵣₑₛₗ^{SyncCC} defining the duration 510-c.

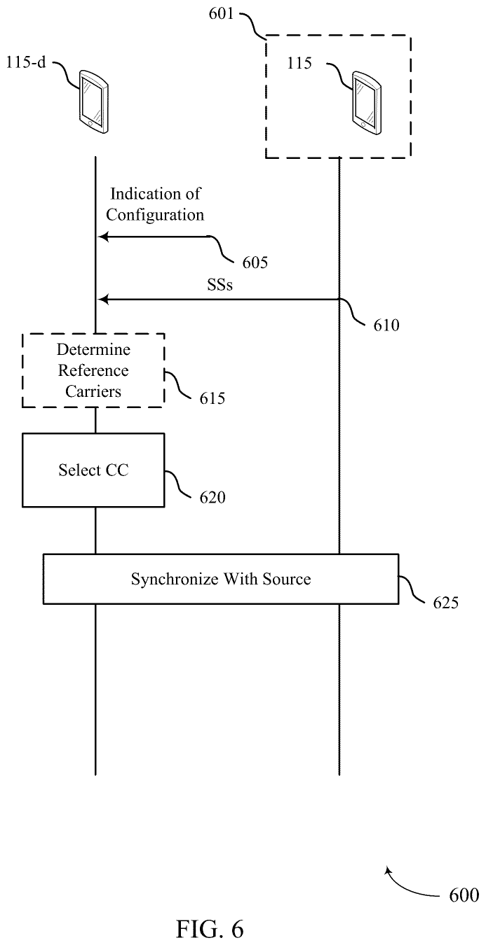

FIG. 6 shows an example of a process flow 600 that supports techniques for sidelink synchronization in accordance with one or more aspects of the present disclosure. The process flow 600 may implement or be implemented to realize aspects of the wireless communications system 100, the subframe diagram 201, the resource diagram 202, the subframe diagram 300, the wireless communications system 400, and the signaling diagram 500. For example, the process flow 600 illustrates communication between a UE 115-d and a wireless device 601, which may be a network entity 105, a synchronization reference UE 115, or a GNSS 405, as illustrated by and described with reference to FIGS. 1-5.

In the following description of the process flow 600, the operations may be performed (such as reported or provided) in a different order than the order shown, or the operations performed by the example devices may be performed in different orders or at different times. Some operations also may be omitted from the process flow 600, or other operations may be added to the process flow 600. Further, although some operations or signaling may be shown to occur at different times for discussion purposes, these operations may actually occur at the same time or otherwise concurrently.

At 605, the UE 115-d may receive an indication of a configuration for synchronization of a communication link (e.g., a link of the UE 115-d), where the configuration may indicate a set of multiple CCs (e.g., a configuration for synchronization using one or more CCs) and respective priorities associated with the set of multiple CCs for the synchronization (e.g., respective synchronization priorities, such as SLSyncPriorityPerCarrier parameter, or a parameter disabling or enabling each CC, such as slss-TxDisabled). In some examples, the indication of the configuration may be received via an RRC message. Additionally, or alternatively, the indication of the configuration may be indicated by one or more applications, one or more services, or both.

At 610, the UE 115-d may receive a set of multiple SSs via at least a subset of the set of multiple CCs.

At 615, the UE 115-d may optionally determine that a first subset of the set of multiple CCs are reference carriers. In some cases, the first subset of the set of multiple CCs may be determined based on the respective priorities associated with the first subset of the set of multiple CCs being a highest priority value of a set of priority values. Additionally, or alternatively, the first subset of the set of multiple CCs may be indicated by one or more applications or services of the UE 115-d.

At 620, the UE 115-d may select a first CC from the set of multiple CCs, where the first CC of the set of multiple CCs (e.g., for synchronizing with the wireless device 601) may be selected based on the respective priorities associated with the set of multiple CCs.

In some examples, the UE 115-d may select the first CC from one or more of the first subset of the set of multiple CCs having respective received signal powers (e.g., RSRPs) satisfying a threshold received signal power. In some cases, selecting the first CC is based on the wireless device 601 being associated with a synchronization source priority that is higher than or equal to synchronization source priorities associated with other wireless devices associated with the first subset of the set of multiple component carriers. In some examples, the UE 115-d may determine that two or more wireless devices of a set of multiple wireless devices transmitting SSs over the first subset of the set of multiple CCs are associated with a highest synchronization source priority of respective synchronization source priorities associated with the set of multiple wireless devices.

Additionally, or alternatively, the UE 115-d may select the first CC from the set of multiple CCs based on the first subset of the set of multiple CCs having respective received signal powers failing to satisfy a threshold received signal power. In some cases, the UE 115-d may determine that the wireless device 601 has a highest synchronization source priority among a set of multiple wireless devices transmitting SSs over the set of multiple CCs for which respective received signal powers satisfy the threshold received signal power. Further, the first CC may be selected based on a respective priority corresponding to the first CC indicating that the first CC is enabled for the synchronization, where each of the respective priorities may indicate whether a respective CC of the set of multiple CCs is enabled or disabled for the synchronization.

At 625, the UE 115-d may synchronize with the wireless device 601 associated with the first CC of the set of multiple CCs based on the selecting. In some examples, the wireless device 601 may be a second UE, such as a reference UE 115. Additionally, or alternatively, synchronizing with the wireless device 601 associated with the first CC may be based on a received signal power of a SS received over the first CC being greater than a second received signal power of a second SS received via a second CC associated with a second wireless device of the two or more wireless devices associated with the highest synchronization source priority.

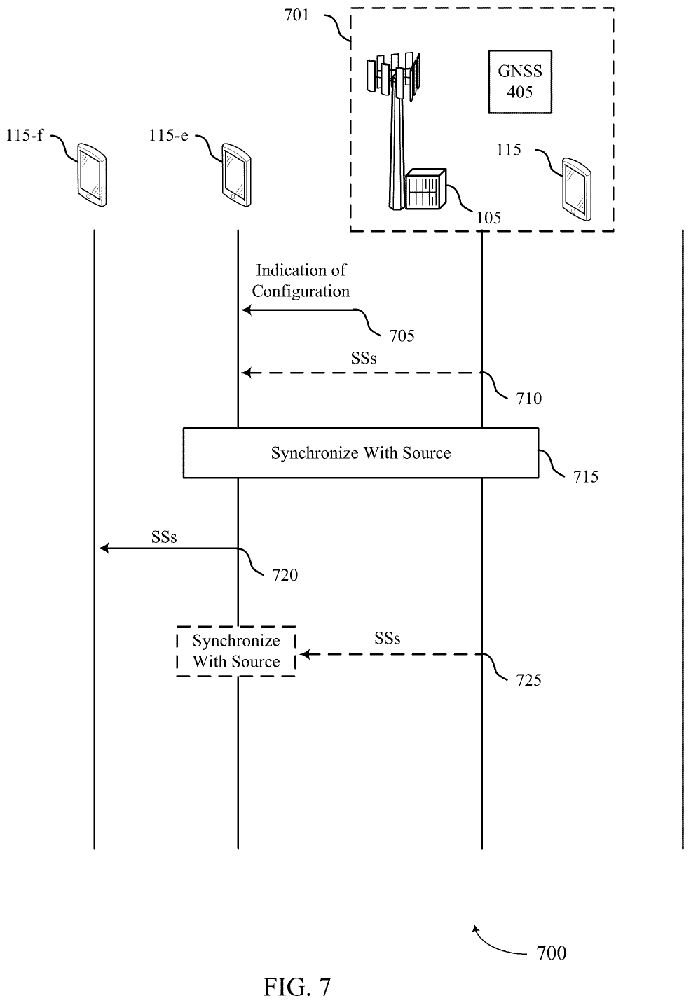

FIG. 7 shows an example of a process flow 700 that supports techniques for sidelink synchronization in accordance with one or more aspects of the present disclosure. The process flow 700 may implement or be implemented to realize aspects of the wireless communications system 100, the subframe diagram 201, the resource diagram 202, the subframe diagram 300, the wireless communications system 400, the signaling diagram 500, and the process flow 600. For example, the process flow 700 illustrates communication between a UE 115-e, a UE 115-f, and a timing source 701, which may be a network entity 105, a synchronization reference UE 115, or a GNSS 405, as illustrated by and described with reference to FIGS. 1-5.

In the following description of the process flow 700, the operations may be performed (such as reported or provided) in a different order than the order shown, or the operations performed by the example devices may be performed in different orders or at different times. Some operations also may be omitted from the process flow 700, or other operations may be added to the process flow 700. Further, although some operations or signaling may be shown to occur at different times for discussion purposes, these operations may actually occur at the same time or otherwise concurrently.

At 705, the UE 115-e may receive an indication of a configuration for synchronization of a communication link (e.g., a link of the UE 115-e), where the configuration may indicate a set of multiple CCs (e.g., a configuration for synchronization or transmitting SSs using one or more CCs) and respective priorities associated with the set of multiple CCs for the synchronization (e.g., respective synchronization priorities, such as SLSyncPriorityPerCarrier parameter, or a parameter disabling or enabling each CC, such as slss-TxDisabled). In some examples, the indication of the configuration may be received via an RRC message (e.g., from a network entity 105). Additionally, or alternatively, the indication of the configuration may indicated by one or more applications, one or more services, or both.

At 710, the UE 115-e may optionally receive one or more SSs from the timing source 701, from one or more additional timing sources, or both. In some examples, a timing source may be an example of a timing of communications of a wireless device, or another source for synchronizing timing of communications that may or may not be associated with one wireless device, or may be a different timing source. In some examples, the UE 115-e may receive an SS via a first CC during a first time duration associated with a first timer.

At 715, the UE 115-e may synchronize with the timing source 701. In some examples, the timing source 701 may be a wireless device associated with a first CC in a second subset of the set of multiple CCs different from a first subset of the set of multiple CCs including one or more reference carriers for synchronization. In some cases, the timing source may be a network entity 105, a GNSS 405, or a second UE 115, such as a synchronization reference UE.

At 720, the UE 115-e may transmit SSs via one or more of the set of multiple CCs based on the synchronizing with the timing source 701 at 715 and the respective priorities associated with the set of multiple CCs. For example, the UE 115-e may transmit the SSs to the UE 115-f. In some examples, the UE 115-e may transmit, subsequent to expiry of the first timer, the SSs during a second time duration associated with a second timer. In some examples, transmitting the SSs via the one or more of the set of multiple CCs may be based on one or more SSs received via the first CC, based on the second subset of the set of multiple CCs being associated with a priority different from a highest priority of the respective priorities, or both.

In some examples, the UE 115-e may transmit the SSs via each of the set of multiple CCs based on a capability of the UE.

By way of another example, the UE 115-e may transmit the SSs via a first CC of the set of multiple CCs based on a first wireless device of the first CC (e.g., a wireless device of the timing source 701) being associated with a lowest synchronization source priority of respective synchronization source priorities associated with a set of multiple wireless devices associated with the set of multiple CCs and based on a capability of the UE.

Additionally, or alternatively, the UE 115-e may transmit the SSs via a first CC of the set of multiple CCs based on a received signal power of an SS received via the first CC being less than a received signal power of a second SS received via a second CC of the set of multiple CCs and based on a capability of the UE.

In some examples, the UE 115-e may transmit the SSs via one or more CCs of a first subset of the set of multiple CCs based on received signal powers of respective SSs received via the first subset of the set of multiple CCs failing to satisfy a threshold received signal power, where the first subset of the set of multiple CCs may include one or more reference carriers for synchronization. Additionally, or alternatively, the UE 115-e may transmit the SSs via one or more CCs of a second subset of the set of multiple CCs different from the first subset of the set of multiple CCs based on received signal powers of respective SSs received via the first subset of the set of multiple CCs satisfying a threshold received signal power and based on received signal powers of respective SSs received via the second subset of the set of multiple CCs failing to satisfy the threshold received signal power. In some examples, respective priorities associated with the second subset of the set of multiple CCs may be lower than a priority associated with the first subset of the set of multiple CCs. In some examples, each of the respective priorities indicates whether a respective CC of the set of multiple CCs is enabled or disabled for the synchronization.

In some examples, the UE 115-e may transmit the SSs via a first CC of the set of multiple CCs, where the first CC may be selected from the plurality of CCs based on a capability of the UE, a synchronization source priority associated with a wireless device of the timing source 701, a received signal power associated with a SS received via the first CC, a random selection, or any combination thereof.

At 725, the UE may optionally synchronize with a second timing source and receive one or more SSs via another subset of the set of multiple CCs. In some examples, the UE may refrain from transmitting one or more additional SSs via one or more of the set of multiple CCs based on synchronizing with the second timing source and based on the additional subset of the set of multiple CCs including one or more reference carriers for synchronization, based on the additional subset of the set of multiple CCs being associated with a highest priority of the respective priorities, or both.

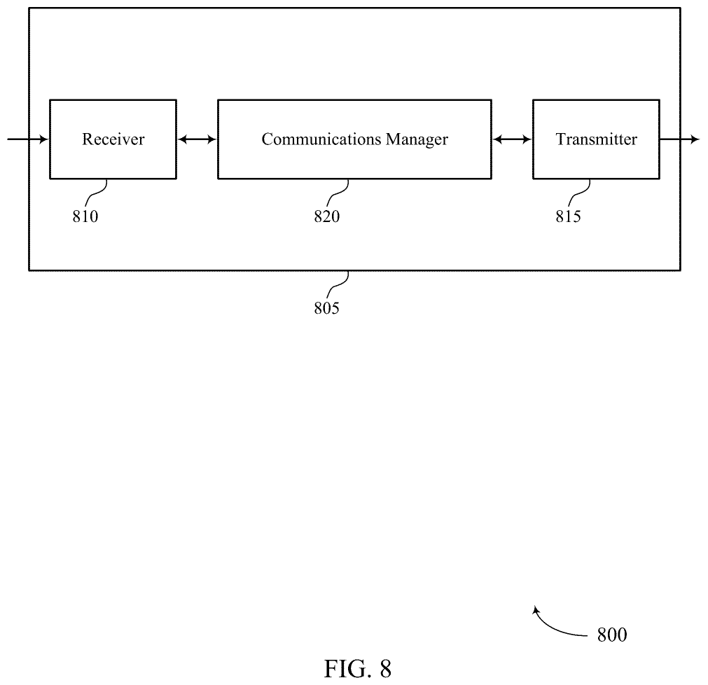

FIG. 8 shows a block diagram 800 of a device 805 that supports techniques for sidelink synchronization in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for sidelink synchronization). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for sidelink synchronization). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for sidelink synchronization as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving an indication of a configuration for synchronization of a communication link, where the configuration may indicate a set of multiple component carriers and respective priorities associated with the set of multiple component carriers for the synchronization. The communications manager 820 is capable of, configured to, or operable to support a means for receiving a set of multiple synchronization signals via at least a subset of the set of multiple component carriers. The communications manager 820 is capable of, configured to, or operable to support a means for synchronizing with a wireless device associated with a first component carrier of the set of multiple component carriers, where the first component carrier of the set of multiple component carriers for the synchronizing with the wireless device is selected based on the respective priorities associated with the set of multiple component carriers.

Additionally, or alternatively, the communications manager 820 may support wireless communications in accordance with examples as disclosed herein. For example, the communications manager 820 is capable of, configured to, or operable to support a means for receiving an indication of a configuration for synchronization of a communication link, where the configuration may indicate a set of multiple component carriers and respective priorities associated with the set of multiple component carriers for the synchronization. The communications manager 820 is capable of, configured to, or operable to support a means for synchronizing with a timing source. The communications manager 820 is capable of, configured to, or operable to support a means for transmitting synchronization signals via one or more of the set of multiple component carriers based on the synchronizing with the timing source and the respective priorities associated with the set of multiple component carriers.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources by enabling backwards compatibility and further synchronization in sidelink CA.

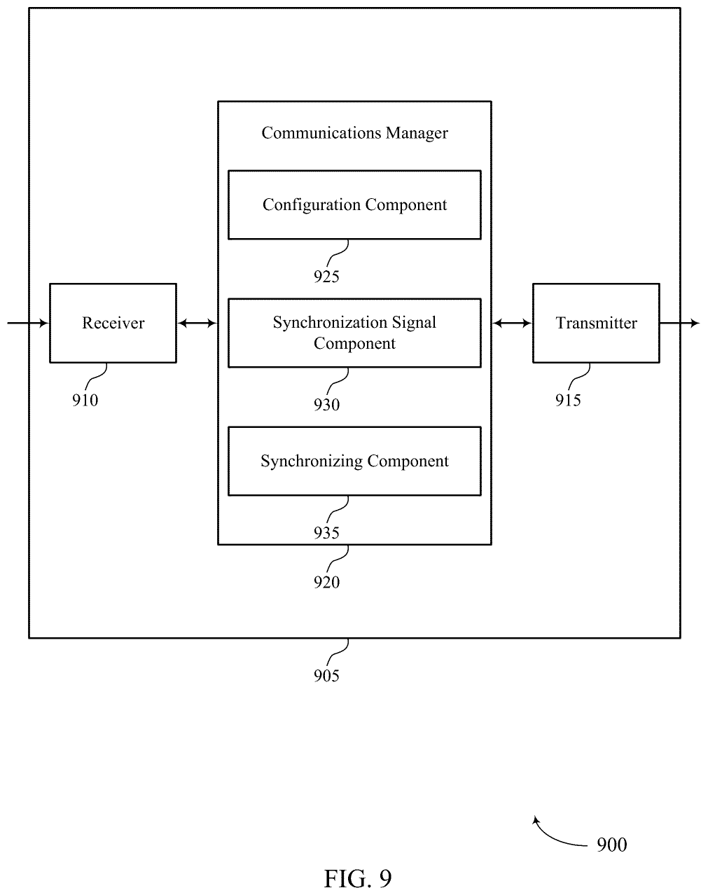

FIG. 9 shows a block diagram 900 of a device 905 that supports techniques for sidelink synchronization in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for sidelink synchronization). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for sidelink synchronization). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for sidelink synchronization as described herein. For example, the communications manager 920 may include a configuration component 925, a synchronization signal component 930, a synchronizing component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The configuration component 925 is capable of, configured to, or operable to support a means for receiving an indication of a configuration for synchronization of a communication link, where the configuration may indicate a set of multiple component carriers and respective priorities associated with the set of multiple component carriers for the synchronization. The synchronization signal component 930 is capable of, configured to, or operable to support a means for receiving a set of multiple synchronization signals via at least a subset of the set of multiple component carriers. The synchronizing component 935 is capable of, configured to, or operable to support a means for synchronizing with a wireless device associated with a first component carrier of the set of multiple component carriers, where the first component carrier of the set of multiple component carriers for the synchronizing with the wireless device is selected based on the respective priorities associated with the set of multiple component carriers.

Additionally, or alternatively, the communications manager 920 may support wireless communications in accordance with examples as disclosed herein. The configuration component 925 is capable of, configured to, or operable to support a means for receiving an indication of a configuration for synchronization of a communication link, where the configuration may indicate a set of multiple component carriers and respective priorities associated with the set of multiple component carriers for the synchronization. The synchronizing component 935 is capable of, configured to, or operable to support a means for synchronizing with a timing source. The synchronization signal component 930 is capable of, configured to, or operable to support a means for transmitting synchronization signals via one or more of the set of multiple component carriers based on the synchronizing with the timing source and the respective priorities associated with the set of multiple component carriers.

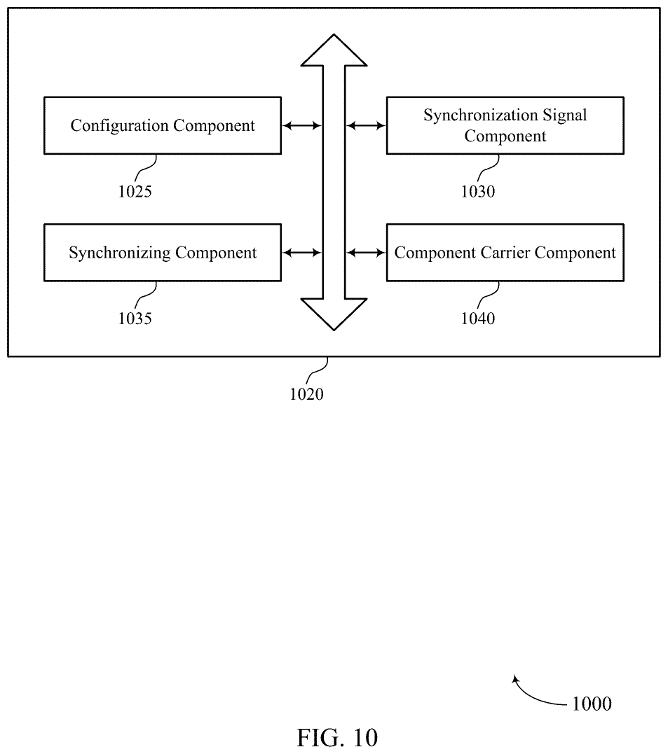

FIG. 10 shows a block diagram 1000 of a communications manager 1020 that supports techniques for sidelink synchronization in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for sidelink synchronization as described herein. For example, the communications manager 1020 may include a configuration component 1025, a synchronization signal component 1030, a synchronizing component 1035, a component carrier component 1040, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The configuration component 1025 is capable of, configured to, or operable to support a means for receiving an indication of a configuration for synchronization of a communication link, where the configuration may indicate a set of multiple component carriers and respective priorities associated with the set of multiple component carriers for the synchronization. The synchronization signal component 1030 is capable of, configured to, or operable to support a means for receiving a set of multiple synchronization signals via at least a subset of the set of multiple component carriers. The synchronizing component 1035 is capable of, configured to, or operable to support a means for synchronizing with a wireless device associated with a first component carrier of the set of multiple component carriers, where the first component carrier of the set of multiple component carriers for the synchronizing with the wireless device is selected based on the respective priorities associated with the set of multiple component carriers.

In some examples, the component carrier component 1040 is capable of, configured to, or operable to support a means for determining that a first subset of the set of multiple component carriers are reference carriers. In some examples, the component carrier component 1040 is capable of, configured to, or operable to support a means for selecting the first component carrier from one or more of the first subset of the set of multiple component carriers having respective received signal powers satisfying a threshold received signal power.

In some examples, selecting the first component carrier is based on the wireless device being associated with a synchronization source priority that is higher than or equal to synchronization source priorities associated with other wireless devices of the first subset of the set of multiple component carriers.

In some examples, the component carrier component 1040 is capable of, configured to, or operable to support a means for determining that two or more wireless devices of a set of multiple wireless devices transmitting synchronization signals over the first subset of the set of multiple component carriers are associated with a highest synchronization source priority of respective synchronization source priorities associated with the set of multiple wireless devices, where synchronizing with the wireless device associated with the first component carrier is based on a received signal power of a synchronization signal received over the first component carrier being greater than a second received signal power of a second synchronization signal received via a second component carrier associated with a second wireless device of the two or more wireless devices.

In some examples, the first subset of the set of multiple component carriers is determined based on the respective priorities associated with the first subset of the set of multiple component carriers being a highest priority value of a set of priority values. In some examples, the first component carrier is selected based on a respective priority corresponding to the first component carrier indicating that the first component carrier is enabled for the synchronization, where each of the respective priorities may indicate whether a respective component carrier of the set of multiple component carriers is enabled or disabled for the synchronization.

In some examples, the component carrier component 1040 is capable of, configured to, or operable to support a means for determining that a first subset of the set of multiple component carriers are reference carriers. In some examples, the component carrier component 1040 is capable of, configured to, or operable to support a means for selecting the first component carrier from the set of multiple component carriers based on the first subset of the set of multiple component carriers having respective received signal powers failing to satisfy a threshold received signal power.

In some examples, the component carrier component 1040 is capable of, configured to, or operable to support a means for determining that the wireless device has a highest synchronization source priority among a set of multiple wireless devices transmitting synchronization signals over the set of multiple component carriers for which respective received signal powers satisfy the threshold received signal power.

In some examples, the wireless device includes a second UE.

In some examples, the indication of the configuration is indicated by one or more applications, one or more services, or both.

In some examples, the indication of the configuration is received via a radio resource control message.

Additionally, or alternatively, the communications manager 1020 may support wireless communications in accordance with examples as disclosed herein. In some examples, the configuration component 1025 is capable of, configured to, or operable to support a means for receiving an indication of a configuration for synchronization of a communication link, where the configuration may indicate a set of multiple component carriers and respective priorities associated with the set of multiple component carriers for the synchronization. In some examples, the synchronizing component 1035 is capable of, configured to, or operable to support a means for synchronizing with a timing source. In some examples, the synchronization signal component 1030 is capable of, configured to, or operable to support a means for transmitting synchronization signals via one or more of the set of multiple component carriers based on the synchronizing with the timing source and the respective priorities associated with the set of multiple component carriers.

In some examples, to support transmitting synchronization signals via one or more of the set of multiple component carriers, the synchronization signal component 1030 is capable of, configured to, or operable to support a means for transmitting synchronization signals via each of the set of multiple component carriers based on a capability of the UE.

In some examples, to support transmitting synchronization signals via one or more of the set of multiple component carriers, the synchronization signal component 1030 is capable of, configured to, or operable to support a means for transmitting synchronization signals via a first component carrier of the set of multiple component carriers based on a first wireless device of the first component carrier being associated with a lowest synchronization source priority of respective synchronization source priorities associated with a set of multiple wireless devices associated with the set of multiple component carriers and based on a capability of the UE.

In some examples, to support transmitting synchronization signals via one or more of the set of multiple component carriers, the synchronization signal component 1030 is capable of, configured to, or operable to support a means for transmitting synchronization signals via a first component carrier of the set of multiple component carriers based on a received signal power of a synchronization signal received via the first component carrier being less than a received signal power of a second synchronization signal received via a second component carrier of the set of multiple component carriers and based on a capability of the UE.

In some examples, to support transmitting synchronization signals via one or more of the set of multiple component carriers, the synchronization signal component 1030 is capable of, configured to, or operable to support a means for transmitting synchronization signals via one or more component carriers of a first subset of the set of multiple component carriers based on received signal powers of respective synchronization signals received via the first subset of the set of multiple component carriers failing to satisfy a threshold received signal power, where the first subset of the set of multiple component carriers includes one or more reference carriers for synchronization.

In some examples, to support transmitting synchronization signals via one or more of the set of multiple component carriers, the synchronization signal component 1030 is capable of, configured to, or operable to support a means for transmitting synchronization signals via one or more component carriers of a second subset of the set of multiple component carriers different from a first subset of the set of multiple component carriers based on received signal powers of respective synchronization signals received via the first subset of the set of multiple component carriers satisfying a threshold received signal power and based on received signal powers of respective synchronization signals received via the second subset of the set of multiple component carriers failing to satisfy the threshold received signal power, where the first subset of the set of multiple component carriers includes one or more reference carriers for synchronization.

In some examples, respective priorities associated with the second subset of the set of multiple component carriers are lower than a priority associated with the first subset of the set of multiple component carriers. In some examples, each of the respective priorities indicates whether a respective component carrier of the set of multiple component carriers is enabled or disabled for the synchronization.

In some examples, the timing source includes a wireless device associated with a first component carrier in a second subset of the set of multiple component carriers different from a first subset of the set of multiple component carriers including one or more reference carriers for synchronization, or transmitting the synchronization signals via the one or more of the set of multiple component carriers is based on one or more synchronization signals received via the first component carrier, the second subset of the set of multiple component carriers being associated with a priority different from a highest priority of the respective priorities, or both.

In some examples, the synchronizing component 1035 is capable of, configured to, or operable to support a means for synchronizing with a second timing source. In some examples, the synchronization signal component 1030 is capable of, configured to, or operable to support a means for receiving one or more synchronization signals via a first subset of the set of multiple component carriers. In some examples, the synchronization signal component 1030 is capable of, configured to, or operable to support a means for refraining from transmitting one or more additional synchronization signals via one or more of the set of multiple component carriers based on synchronizing with the second timing source and based on the first subset of the set of multiple component carriers including one or more reference carriers for synchronization, the first subset of the set of multiple component carriers being associated with a highest priority of the respective priorities, or both.

In some examples, to support transmitting synchronization signals via one or more of the set of multiple component carriers, the synchronization signal component 1030 is capable of, configured to, or operable to support a means for transmitting synchronization signals via a first component carrier of the set of multiple component carriers, where the first component carrier is selected from the set of multiple component carriers based on a capability of the UE, a synchronization source priority associated with a wireless device of the timing source, a received signal power associated with a synchronization signal received via the first component carrier, a random selection, or any combination thereof.

In some examples, the timing source includes a network entity, a Global Navigation Satellite System (GNSS), or a second UE.

In some examples, the timing source includes a wireless device associated with a first component carrier in a second subset of the set of multiple component carriers that is different from a first subset of the set of multiple component carriers. In some examples, the first subset of the set of multiple component carriers includes reference carriers for synchronization. In some examples, the UE receives a synchronization signal via the first component carrier during a first time duration associated with a first timer and transmits, subsequent to expiry of the first timer, the synchronization signals during a second time duration associated with a second timer.

In some examples, the indication of the configuration is indicated by one or more applications, one or more services, or both.

In some examples, the indication of the configuration is received via a radio resource control message.

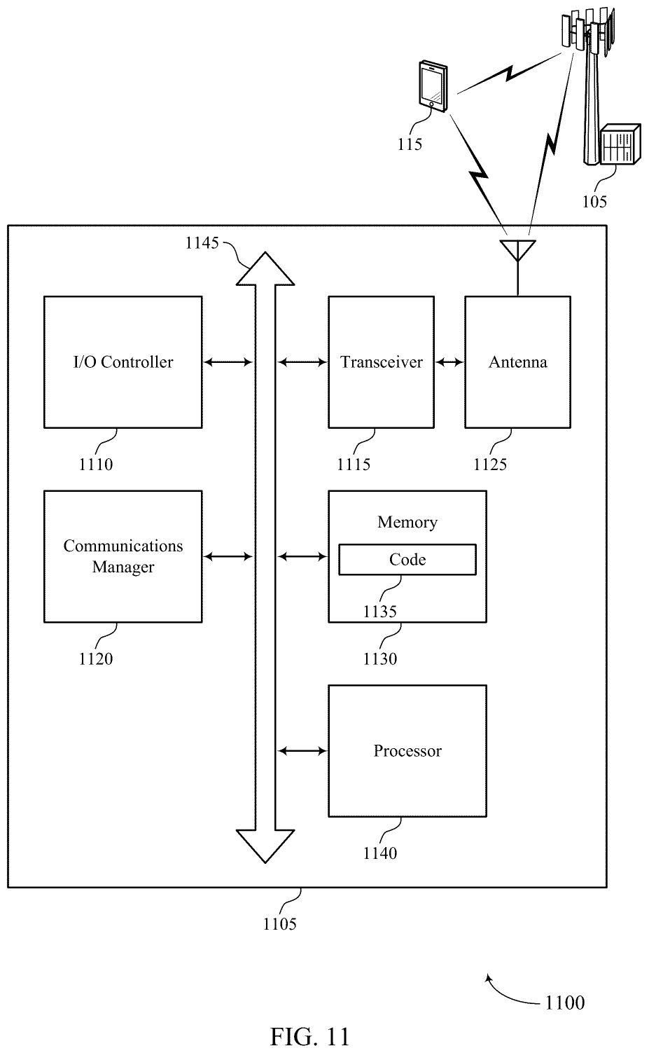

FIG. 11 shows a diagram of a system 1100 including a device 1105 that supports techniques for sidelink synchronization in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable code 1135 including instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may contain, among other things, a basic I/O system (BIOS) which may control basic hardware or software operation such as the interaction with peripheral components or devices.

The at least one processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting techniques for sidelink synchronization). For example, the device 1105 or a component of the device 1105 may include at least one processor 1140 and at least one memory 1130 coupled with or to the at least one processor 1140, the at least one processor 1140 and at least one memory 1130 configured to perform various functions described herein. In some examples, the at least one processor 1140 may include multiple processors and the at least one memory 1130 may include multiple memories. One or more of the multiple processors may be coupled with one or more of the multiple memories, which may, individually or collectively, be configured to perform various functions herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. As such, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving an indication of a configuration for synchronization of a communication link, where the configuration may indicate a set of multiple component carriers and respective priorities associated with the set of multiple component carriers for the synchronization. The communications manager 1120 is capable of, configured to, or operable to support a means for receiving a set of multiple synchronization signals via at least a subset of the set of multiple component carriers. The communications manager 1120 is capable of, configured to, or operable to support a means for synchronizing with a wireless device associated with a first component carrier of the set of multiple component carriers, where the first component carrier of the set of multiple component carriers for the synchronizing with the wireless device is selected based on the respective priorities associated with the set of multiple component carriers.

Additionally, or alternatively, the communications manager 1120 may support wireless communications in accordance with examples as disclosed herein. For example, the communications manager 1120 is capable of, configured to, or operable to support a means for receiving an indication of a configuration for synchronization of a communication link, where the configuration may indicate a set of multiple component carriers and respective priorities associated with the set of multiple component carriers for the synchronization. The communications manager 1120 is capable of, configured to, or operable to support a means for synchronizing with a timing source. The communications manager 1120 is capable of, configured to, or operable to support a means for transmitting synchronization signals via one or more of the set of multiple component carriers based on the synchronizing with the timing source and the respective priorities associated with the set of multiple component carriers.

By including or configuring the communications manager 1120 in accordance with examples as described herein, the device 1105 may support techniques for improved communication reliability, reduced latency, more efficient utilization of communication resources, and improved coordination between devices by enabling backwards compatibility and further synchronization in sidelink CA.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of techniques for sidelink synchronization as described herein, or the at least one processor 1140 and the at least one memory 1130 may be otherwise configured to, individually or collectively, perform or support such operations.

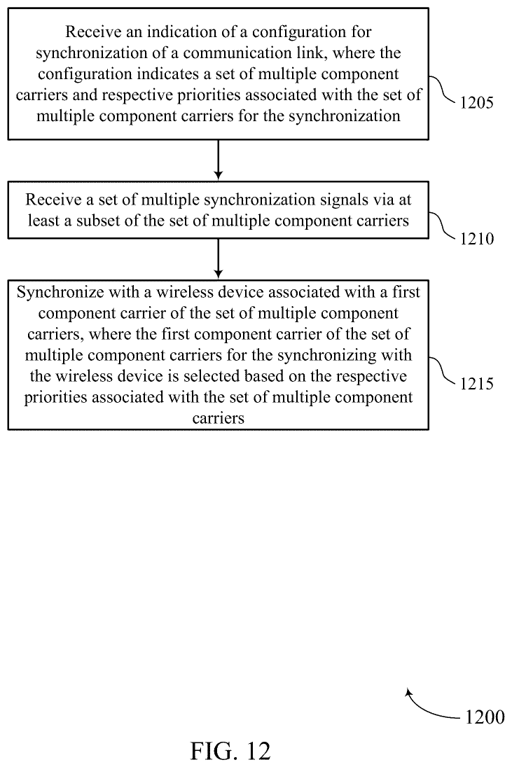

FIG. 12 shows a flowchart illustrating a method 1200 that supports techniques for sidelink synchronization in accordance with aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving an indication of a configuration for synchronization of a communication link, where the configuration indicates a set of multiple component carriers and respective priorities associated with the set of multiple component carriers for the synchronization. The operations of block 1205 may be performed in accordance with examples as disclosed herein. In some examples, aspects of the operations of 1205 may be performed by a configuration component 1025 as described with reference to FIG. 10.

At 1210, the method may include receiving a set of multiple synchronization signals via at least a subset of the set of multiple component carriers. The operations of block 1210 may be performed in accordance with examples as disclosed herein. In some examples, aspects of the operations of 1210 may be performed by a synchronization signal component 1030 as described with reference to FIG. 10.

At 1215, the method may include synchronizing with a wireless device associated with a first component carrier of the set of multiple component carriers, where the first component carrier of the set of multiple component carriers for the synchronizing with the wireless device is selected based on the respective priorities associated with the set of multiple component carriers. The operations of block 1215 may be performed in accordance with examples as disclosed herein. In some examples, aspects of the operations of 1215 may be performed by a synchronizing component 1035 as described with reference to FIG. 10.

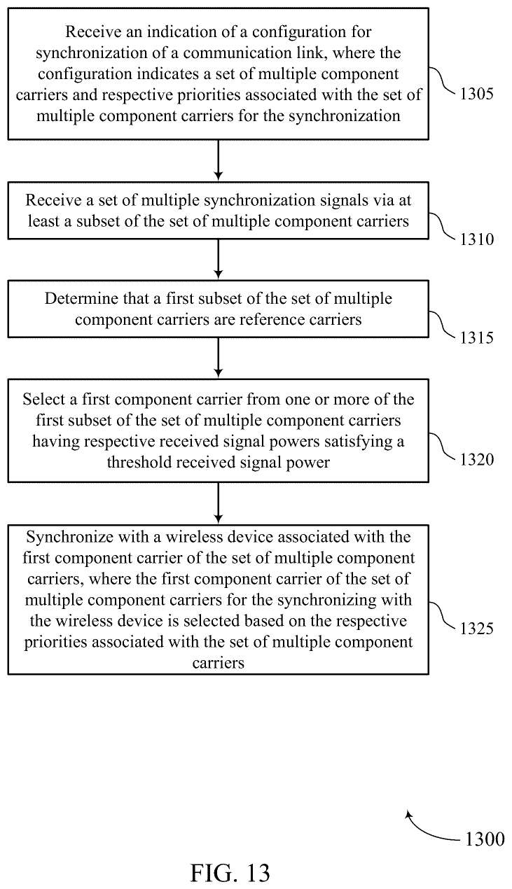

FIG. 13 shows a flowchart illustrating a method 1300 that supports techniques for sidelink synchronization in accordance with aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a configuration for synchronization of a communication link, where the configuration indicates a set of multiple component carriers and respective priorities associated with the set of multiple component carriers for the synchronization. The operations of block 1305 may be performed in accordance with examples as disclosed herein. In some examples, aspects of the operations of 1305 may be performed by a configuration component 1025 as described with reference to FIG. 10.

At 1310, the method may include receiving a set of multiple synchronization signals via at least a subset of the set of multiple component carriers. The operations of block 1310 may be performed in accordance with examples as disclosed herein. In some examples, aspects of the operations of 1310 may be performed by a synchronization signal component 1030 as described with reference to FIG. 10.

At 1315, the method may include determining that a first subset of the set of multiple component carriers are reference carriers. The operations of block 1315 may be performed in accordance with examples as disclosed herein. In some examples, aspects of the operations of 1315 may be performed by a component carrier component 1040 as described with reference to FIG. 10.

At 1320, the method may include selecting a first component carrier from one or more of the first subset of the set of multiple component carriers having respective received signal powers satisfying a threshold received signal power. The operations of block 1320 may be performed in accordance with examples as disclosed herein. In some examples, aspects of the operations of 1320 may be performed by a component carrier component 1040 as described with reference to FIG. 10.

At 1325, the method may include synchronizing with a wireless device associated with the first component carrier of the set of multiple component carriers, where the first component carrier of the set of multiple component carriers for the synchronizing with the wireless device is selected based on the respective priorities associated with the set of multiple component carriers. The operations of block 1325 may be performed in accordance with examples as disclosed herein. In some examples, aspects of the operations of 1325 may be performed by a synchronizing component 1035 as described with reference to FIG. 10.

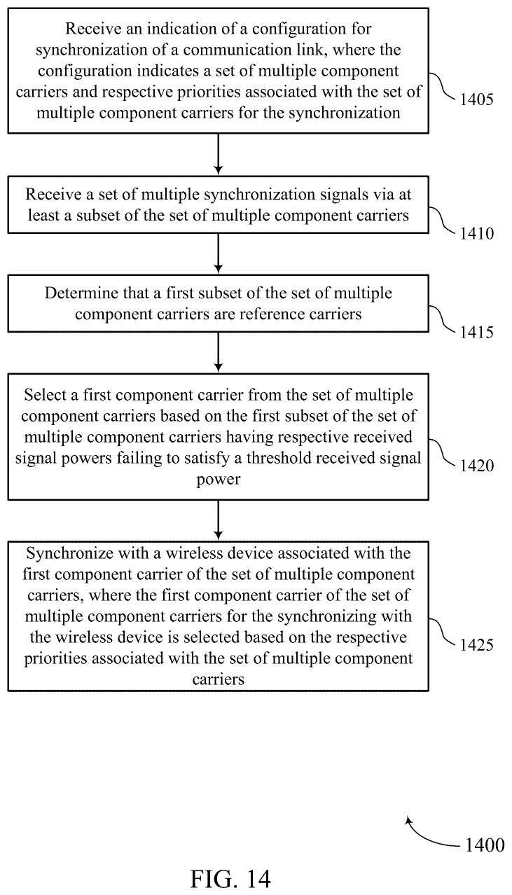

FIG. 14 shows a flowchart illustrating a method 1400 that supports techniques for sidelink synchronization in accordance with aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving an indication of a configuration for synchronization of a communication link, where the configuration indicates a set of multiple component carriers and respective priorities associated with the set of multiple component carriers for the synchronization. The operations of block 1405 may be performed in accordance with examples as disclosed herein. In some examples, aspects of the operations of 1405 may be performed by a configuration component 1025 as described with reference to FIG. 10.

At 1410, the method may include receiving a set of multiple synchronization signals via at least a subset of the set of multiple component carriers. The operations of block 1410 may be performed in accordance with examples as disclosed herein. In some examples, aspects of the operations of 1410 may be performed by a synchronization signal component 1030 as described with reference to FIG. 10.

At 1415, the method may include determining that a first subset of the set of multiple component carriers are reference carriers. The operations of block 1415 may be performed in accordance with examples as disclosed herein. In some examples, aspects of the operations of 1415 may be performed by a component carrier component 1040 as described with reference to FIG. 10.

At 1420, the method may include selecting a first component carrier from the set of multiple component carriers based on the first subset of the set of multiple component carriers having respective received signal powers failing to satisfy a threshold received signal power. The operations of block 1420 may be performed in accordance with examples as disclosed herein. In some examples, aspects of the operations of 1420 may be performed by a component carrier component 1040 as described with reference to FIG. 10.

At 1425, the method may include synchronizing with a wireless device associated with the first component carrier of the set of multiple component carriers, where the first component carrier of the set of multiple component carriers for the synchronizing with the wireless device is selected based on the respective priorities associated with the set of multiple component carriers. The operations of block 1425 may be performed in accordance with examples as disclosed herein. In some examples, aspects of the operations of 1425 may be performed by a synchronizing component 1035 as described with reference to FIG. 10.

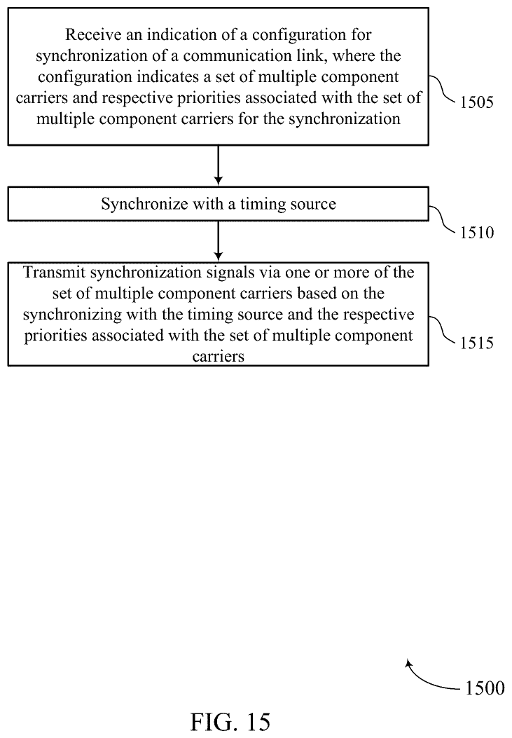

FIG. 15 shows a flowchart illustrating a method 1500 that supports techniques for sidelink synchronization in accordance with aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include receiving an indication of a configuration for synchronization of a communication link, where the configuration indicates a set of multiple component carriers and respective priorities associated with the set of multiple component carriers for the synchronization. The operations of block 1505 may be performed in accordance with examples as disclosed herein. In some examples, aspects of the operations of 1505 may be performed by a configuration component 1025 as described with reference to FIG. 10.

At 1510, the method may include synchronizing with a timing source. The operations of block 1510 may be performed in accordance with examples as disclosed herein. In some examples, aspects of the operations of 1510 may be performed by a synchronizing component 1035 as described with reference to FIG. 10.

At 1515, the method may include transmitting synchronization signals via one or more of the set of multiple component carriers based on the synchronizing with the timing source and the respective priorities associated with the set of multiple component carriers. The operations of block 1515 may be performed in accordance with examples as disclosed herein. In some examples, aspects of the operations of 1515 may be performed by a synchronization signal component 1030 as described with reference to FIG. 10.

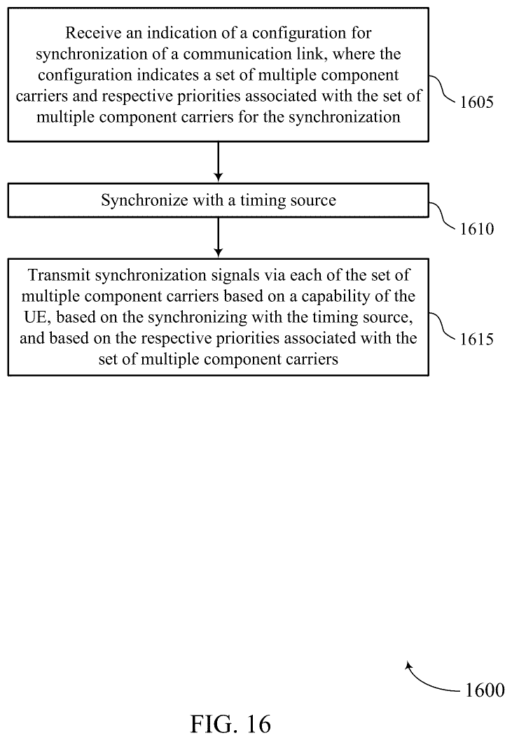

FIG. 16 shows a flowchart illustrating a method 1600 that supports techniques for sidelink synchronization in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving an indication of a configuration for synchronization of a communication link, where the configuration indicates a set of multiple component carriers and respective priorities associated with the set of multiple component carriers for the synchronization. The operations of block 1605 may be performed in accordance with examples as disclosed herein. In some examples, aspects of the operations of 1605 may be performed by a configuration component 1025 as described with reference to FIG. 10.

At 1610, the method may include synchronizing with a timing source. The operations of block 1610 may be performed in accordance with examples as disclosed herein. In some examples, aspects of the operations of 1610 may be performed by a synchronizing component 1035 as described with reference to FIG. 10.

At 1615, the method may include transmitting synchronization signals via each of the set of multiple component carriers based on a capability of the UE, based on the synchronizing with the timing source, and based on the respective priorities associated with the set of multiple component carriers. The operations of block 1615 may be performed in accordance with examples as disclosed herein. In some examples, aspects of the operations of 1615 may be performed by a synchronization signal component 1030 as described with reference to FIG. 10.

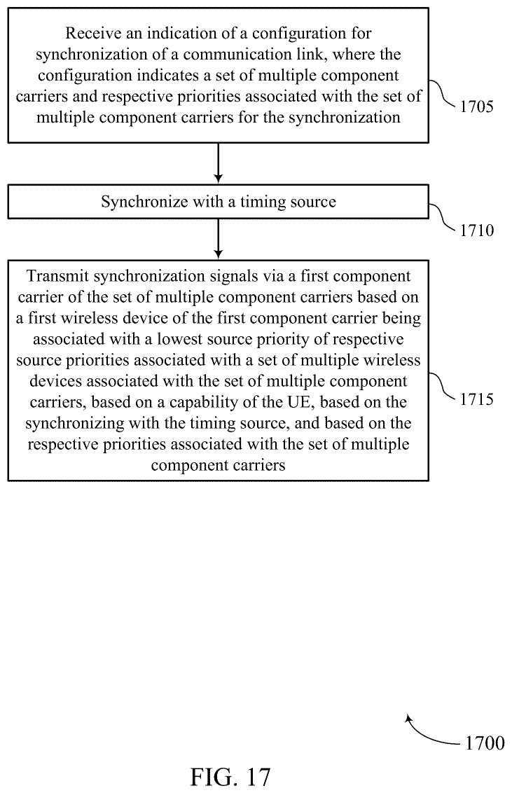

FIG. 17 shows a flowchart illustrating a method 1700 that supports techniques for sidelink synchronization in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving an indication of a configuration for synchronization of a communication link, where the configuration indicates a set of multiple component carriers and respective priorities associated with the set of multiple component carriers for the synchronization. The operations of block 1705 may be performed in accordance with examples as disclosed herein. In some examples, aspects of the operations of 1705 may be performed by a configuration component 1025 as described with reference to FIG. 10.

At 1710, the method may include synchronizing with a timing source. The operations of block 1710 may be performed in accordance with examples as disclosed herein. In some examples, aspects of the operations of 1710 may be performed by a synchronizing component 1035 as described with reference to FIG. 10.

At 1715, the method may include transmitting synchronization signals via a first component carrier of the set of multiple component carriers based on a first wireless device of the first component carrier being associated with a lowest synchronization source priority of respective synchronization source priorities associated with a set of multiple wireless devices associated with the set of multiple component carriers, based on a capability of the UE, based on the synchronizing with the timing source, and based on the respective priorities associated with the set of multiple component carriers. The operations of block 1715 may be performed in accordance with examples as disclosed herein. In some examples, aspects of the operations of 1715 may be performed by a synchronization signal component 1030 as described with reference to FIG. 10.

The following provides an overview of aspects of the present disclosure:
Aspect 1: A method for wireless communication by a UE, comprising: receiving an indication of a configuration for synchronization of a communication link, where the configuration indicates a plurality of component carriers (e.g., a configuration for synchronization using one or more CCs) and respective priorities associated with the plurality of component carriers for the synchronization (e.g., respective synchronization priorities, such as SLSyncPriorityPerCarrier parameter, or a parameter disabling or enabling each CC, such as slss-TxDisabled); receiving a plurality of synchronization signals via at least a subset of the plurality of component carriers; and synchronizing with a wireless device associated with a first component carrier of the plurality of component carriers, wherein the first component carrier of the plurality of component carriers for the synchronizing with the wireless device is selected based at least in part on the respective priorities associated with the plurality of component carriers.
Aspect 2: The method of aspect 1, further comprising: determining that a first subset of the plurality of component carriers are reference carriers; and selecting the first component carrier from one or more of the first subset of the plurality of component carriers having respective received signal powers satisfying a threshold received signal power.
Aspect 3: The method of aspect 2, wherein selecting the first component carrier is based at least in part on the wireless device being associated with a synchronization source priority that is higher than or equal to synchronization source priorities associated with other wireless devices of the first subset of the plurality of component carriers.
Aspect 4: The method of aspect 2, further comprising: determining that two or more wireless devices of a plurality of wireless devices transmitting synchronization signals over the first subset of the plurality of component carriers are associated with a highest synchronization source priority of respective synchronization source priorities associated with the plurality of wireless devices, wherein synchronizing with the wireless device associated with the first component carrier is based at least in part on a received signal power of a synchronization signal received over the first component carrier being greater than a second received signal power of a second synchronization signal received via a second component carrier associated with a second wireless device of the two or more wireless devices.
Aspect 5: The method of any of aspects 2 through 4, wherein the first subset of the plurality of component carriers is determined based at least in part on the respective priorities associated with the first subset of the plurality of component carriers being a highest priority value of a set of priority values.
Aspect 6: The method of aspect 1, wherein the first component carrier is selected based at least in part on a respective priority corresponding to the first component carrier indicating that the first component carrier is enabled for the synchronization (e.g., a value of a respective slss-TxDisabled parameter), wherein each of the respective priorities indicates whether a respective component carrier of the plurality of component carriers is enabled or disabled for the synchronization.
Aspect 7: The method of aspect 1, further comprising: determining that a first subset of the plurality of component carriers are reference carriers; and selecting the first component carrier from the plurality of component carriers based at least in part on the first subset of the plurality of component carriers having respective received signal powers failing to satisfy a threshold received signal power (e.g., a reference carrier may be selected based on being enabled while other carriers are disabled, for example, regardless of RSRP).
Aspect 8: The method of aspect 7, further comprising: determining that the wireless device has a highest synchronization source priority among a plurality of wireless devices transmitting synchronization signals over the plurality of component carriers for which respective received signal powers satisfy the threshold received signal power.
Aspect 9: The method of any of aspects 1 through 8, wherein the wireless device comprises a second UE.
Aspect 10: The method of any of aspects 1 through 9, wherein the indication of the configuration is indicated by one or more applications, one or more services, or both.
Aspect 11: The method of any of aspects 1 through 10, wherein the indication of the configuration is received via a radio resource control message.
Aspect 12: A method for wireless communication by a UE, comprising: receiving an indication of a configuration for synchronization of a communication link, where the configuration indicates a plurality of component carriers (e.g., a configuration for synchronization and transmitting SSs using one or more CCs) and respective priorities associated with the plurality of component carriers for the synchronization (e.g., respective synchronization priorities, such as SLSyncPriorityPerCarrier parameter, or a parameter disabling or enabling each CC, such as slss-TxDisabled); synchronizing with a timing source; and transmitting synchronization signals via one or more of the plurality of component carriers based at least in part on the synchronizing with the timing source and the respective priorities associated with the plurality of component carriers.
Aspect 13: The method of aspect 12, wherein transmitting synchronization signals via one or more of the plurality of component carriers comprises: transmitting synchronization signals via each of the plurality of component carriers based at least in part on a capability of the UE.
Aspect 14: The method of aspect 12, wherein transmitting synchronization signals via one or more of the plurality of component carriers comprises: transmitting synchronization signals via a first component carrier of the plurality of component carriers based at least in part on a first wireless device of the first component carrier being associated with a lowest synchronization source priority of respective synchronization source priorities associated with a plurality of wireless devices associated with the plurality of component carriers and based at least in part on a capability of the UE.
Aspect 15: The method of any of aspects 12 and 14, wherein transmitting synchronization signals via one or more of the plurality of component carriers comprises: transmitting synchronization signals via a first component carrier of the plurality of component carriers based at least in part on a received signal power of a synchronization signal received via the first component carrier being less than a received signal power of a second synchronization signal received via a second component carrier of the plurality of component carriers and based at least in part on a capability of the UE.
Aspect 16: The method of any of aspects 12 through 15, wherein transmitting synchronization signals via one or more of the plurality of component carriers comprises: transmitting synchronization signals via one or more component carriers of a first subset of the plurality of component carriers based at least in part on received signal powers of respective synchronization signals received via the first subset of the plurality of component carriers failing to satisfy a threshold received signal power, wherein the first subset of the plurality of component carriers comprises one or more reference carriers for synchronization.
Aspect 17: The method of any of aspects 12 through 15, wherein transmitting synchronization signals via one or more of the plurality of component carriers comprises: transmitting synchronization signals via one or more component carriers of a second subset of the plurality of component carriers different from a first subset of the plurality of component carriers based at least in part on received signal powers of respective synchronization signals received via the first subset of the plurality of component carriers satisfying a threshold received signal power and based at least in part on received signal powers of respective synchronization signals received via the second subset of the plurality of component carriers failing to satisfy the threshold received signal power, wherein the first subset of the plurality of component carriers comprises one or more reference carriers for synchronization.
Aspect 18: The method of aspect 17, wherein respective priorities associated with the second subset of the plurality of component carriers are lower than a priority associated with the first subset of the plurality of component carriers.
Aspect 19: The method of aspect 12 through 18, wherein each of the respective priorities indicates whether a respective component carrier of the plurality of component carriers is enabled or disabled for the synchronization.
Aspect 20: The method of any of aspects 12 through 15, 17, and 18, wherein the timing source comprises a wireless device associated with a first component carrier in a second subset of the plurality of component carriers different from a first subset of the plurality of component carriers comprising one or more reference carriers for synchronization, transmitting the synchronization signals via the one or more of the plurality of component carriers is based at least in part on one or more synchronization signals received via the first component carrier, the second subset of the plurality of component carriers being associated with a priority different from a highest priority of the respective priorities, or both.
Aspect 21: The method of any of aspects 12 through 20, further comprising: synchronizing with a second timing source; receiving one or more synchronization signals via a first subset of the plurality of component carriers; and refraining from transmitting one or more additional synchronization signals via one or more of the plurality of component carriers based at least in part on synchronizing with the second timing source and based at least in part on the first subset of the plurality of component carriers comprising one or more reference carriers for synchronization, the first subset of the plurality of component carriers being associated with a highest priority of the respective priorities, or both.
Aspect 22: The method of any of aspects 12 and 14 through 21, wherein transmitting synchronization signals via one or more of the plurality of component carriers comprises: transmitting synchronization signals via a first component carrier of the plurality of component carriers, wherein the first component carrier is selected from the plurality of component carriers based at least in part on a capability of the UE, a synchronization source priority associated with a wireless device of the timing source, a received signal power associated with a synchronization signal received via the first component carrier, a random selection, or any combination thereof.
Aspect 23: The method of any of aspects 12 through 22, wherein the timing source comprises a network entity, a Global Navigation Satellite System (GNSS), or a second UE.
Aspect 24: The method of any of aspects 12 through 23, wherein the timing source comprises a wireless device associated with a first component carrier in a second subset of the plurality of component carriers that is different from a first subset of the plurality of component carriers, the first subset of the plurality of component carriers comprises reference carriers for synchronization, and the UE receives a synchronization signal via the first component carrier during a first time duration associated with a first timer and transmits, subsequent to expiry of the first timer, the synchronization signals during a second time duration associated with a second timer.
Aspect 25: The method of any of aspects 12 through 24, wherein the indication of the configuration is indicated by one or more applications, one or more services, or both.
Aspect 26: The method of any of aspects 12 through 25, wherein the indication of the configuration is received via a radio resource control message.
Aspect 27: A UE for wireless communications, comprising one or more memories storing processor-executable code, and one or more processors coupled with the one or more memories and individually or collectively operable to execute the code to cause the UE to perform a method of any of aspects 1 through 11.
Aspect 28: A UE for wireless communications, comprising at least one means for performing a method of any of aspects 1 through 11.
Aspect 29: A non-transitory computer-readable medium storing code for wireless communications, the code comprising instructions executable by a processor to perform a method of any of aspects 1 through 11.
Aspect 30: A UE for wireless communications, comprising one or more memories storing processor-executable code, and one or more processors coupled with the one or more memories and individually or collectively operable to execute the code to cause the UE to perform a method of any of aspects 12 through 26.
Aspect 31: A UE for wireless communications, comprising at least one means for performing a method of any of aspects 12 through 26.
Aspect 32: A non-transitory computer-readable medium storing code for wireless communications, the code comprising instructions executable by a processor to perform a method of any of aspects 12 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an indication of a configuration for synchronization of a communication link, wherein the configuration indicates a plurality of component carriers and respective priorities associated with the plurality of component carriers for the synchronization;
receive a plurality of synchronization signals via at least a subset of the plurality of component carriers; and
synchronize with a wireless device associated with a first component carrier of the plurality of component carriers, wherein the first component carrier of the plurality of component carriers for the synchronizing with the wireless device is selected based at least in part on the respective priorities associated with the plurality of component carriers.

2. The UE of claim 1, wherein the one or more processors are individually or collectively further operable to execute the code to cause the UE to:
determine that a first subset of the plurality of component carriers are reference carriers; and
select the first component carrier from one or more of the first subset of the plurality of component carriers having respective received signal powers satisfying a threshold received signal power.

3. The UE of claim 2, wherein selecting the first component carrier is based at least in part on the wireless device being associated with a synchronization source priority that is higher than or equal to synchronization source priorities associated with other wireless devices of the first subset of the plurality of component carriers.

4. The UE of claim 2, wherein the one or more processors are individually or collectively further operable to execute the code to cause the UE to:
determine that two or more wireless devices of a plurality of wireless devices transmitting synchronization signals over the first subset of the plurality of component carriers are associated with a highest synchronization source priority of respective synchronization source priorities associated with the plurality of wireless devices, wherein synchronizing with the wireless device associated with the first component carrier is based at least in part on a received signal power of a synchronization signal received over the first component carrier being greater than a second received signal power of a second synchronization signal received via a second component carrier associated with a second wireless device of the two or more wireless devices.

5. The UE of claim 2, wherein the first subset of the plurality of component carriers is determined based at least in part on the respective priorities associated with the first subset of the plurality of component carriers being a highest priority value of a set of priority values.

6. The UE of claim 1, wherein the first component carrier is selected based at least in part on a respective priority corresponding to the first component carrier indicating that the first component carrier is enabled for the synchronization, wherein each of the respective priorities indicates whether a respective component carrier of the plurality of component carriers is enabled or disabled for the synchronization.

7. The UE of claim 1, wherein the one or more processors are individually or collectively further operable to execute the code to cause the UE to:
determine that a first subset of the plurality of component carriers are reference carriers; and
select the first component carrier from the plurality of component carriers based at least in part on the first subset of the plurality of component carriers having respective received signal powers failing to satisfy a threshold received signal power, wherein the wireless device has a highest synchronization source priority among a plurality of wireless devices transmitting synchronization signals over the plurality of component carriers for which respective received signal powers satisfy the threshold received signal power.

8. The UE of claim 1, wherein the indication of the configuration is indicated by one or more applications, one or more services, received via a radio resource control message, or any combination thereof.

9. A user equipment (UE), comprising:
one or more memories storing processor-executable code; and
one or more processors coupled with the one or more memories and individually or collectively operable to execute the code to cause the UE to:
receive an indication of a configuration for synchronization of a communication link, wherein the configuration indicates a plurality of component carriers and respective priorities associated with the plurality of component carriers for the synchronization;
synchronize with a timing source; and
transmit synchronization signals via one or more of the plurality of component carriers based at least in part on the synchronizing with the timing source and the respective priorities associated with the plurality of component carriers.

10. The UE of claim 9, wherein, to transmit synchronization signals via one or more of the plurality of component carriers, the one or more processors are individually or collectively operable to execute the code to cause the UE to:
transmit synchronization signals via each of the plurality of component carriers based at least in part on a capability of the UE.

11. The UE of claim 9, wherein, to transmit synchronization signals via one or more of the plurality of component carriers, the one or more processors are individually or collectively operable to execute the code to cause the UE to:
transmit synchronization signals via a first component carrier of the plurality of component carriers based at least in part on a first wireless device of the first component carrier being associated with a lowest synchronization source priority of respective synchronization source priorities associated with a plurality of wireless devices associated with the plurality of component carriers and based at least in part on a capability of the UE.

12. The UE of claim 9, wherein, to transmit synchronization signals via one or more of the plurality of component carriers, the one or more processors are individually or collectively operable to execute the code to cause the UE to:
transmit synchronization signals via a first component carrier of the plurality of component carriers based at least in part on a received signal power of a synchronization signal received via the first component carrier being less than a received signal power of a second synchronization signal received via a second component carrier of the plurality of component carriers and based at least in part on a capability of the UE.

13. The UE of claim 9, wherein, to transmit synchronization signals via one or more of the plurality of component carriers, the one or more processors are individually or collectively operable to execute the code to cause the UE to:
transmit synchronization signals via one or more component carriers of a first subset of the plurality of component carriers based at least in part on received signal powers of respective synchronization signals received via the first subset of the plurality of component carriers failing to satisfy a threshold received signal power, wherein the first subset of the plurality of component carriers comprises one or more reference carriers for synchronization.

14. The UE of claim 9, wherein, to transmit synchronization signals via one or more of the plurality of component carriers, the one or more processors are individually or collectively operable to execute the code to cause the UE to:
transmit synchronization signals via one or more component carriers of a second subset of the plurality of component carriers different from a first subset of the plurality of component carriers based at least in part on received signal powers of respective synchronization signals received via the first subset of the plurality of component carriers satisfying a threshold received signal power and based at least in part on received signal powers of respective synchronization signals received via the second subset of the plurality of component carriers failing to satisfy the threshold received signal power, wherein the first subset of the plurality of component carriers comprises one or more reference carriers for synchronization.

15. The UE of claim 9, wherein each of the respective priorities indicates whether a respective component carrier of the plurality of component carriers is enabled or disabled for the synchronization.

16. The UE of claim 9, wherein the timing source comprises a wireless device associated with a first component carrier in a second subset of the plurality of component carriers different from a first subset of the plurality of component carriers comprising one or more reference carriers for synchronization, wherein transmitting the synchronization signals via the one or more of the plurality of component carriers is based at least in part on one or more synchronization signals received via the first component carrier, the second subset of the plurality of component carriers being associated with a priority different from a highest priority of the respective priorities, or both.

17. The UE of claim 9, wherein the one or more processors are individually or collectively further operable to execute the code to cause the UE to:
synchronize with a second timing source;
receive one or more synchronization signals via a first subset of the plurality of component carriers; and
refrain from transmitting one or more additional synchronization signals via one or more of the plurality of component carriers based at least in part on synchronizing with the second timing source and based at least in part on the first subset of the plurality of component carriers comprising one or more reference carriers for synchronization, the first subset of the plurality of component carriers being associated with a highest priority of the respective priorities, or both.

18. The UE of claim 9, wherein, to transmit synchronization signals via one or more of the plurality of component carriers, the one or more processors are individually or collectively operable to execute the code to cause the UE to:
transmit synchronization signals via a first component carrier of the plurality of component carriers, wherein the first component carrier is selected from the plurality of component carriers based at least in part on a capability of the UE, a synchronization source priority associated with a wireless device of the timing source, a received signal power associated with a synchronization signal received via the first component carrier, a random selection, or any combination thereof.

19. The UE of claim 9, wherein the timing source comprises a wireless device associated with a first component carrier in a second subset of the plurality of component carriers that is different from a first subset of the plurality of component carriers, wherein the first subset of the plurality of component carriers comprises reference carriers for synchronization, and wherein the UE receives a synchronization signal via the first component carrier during a first time duration associated with a first timer and transmits, subsequent to expiry of the first timer, the synchronization signals during a second time duration associated with a second timer.

20. A method for wireless communication by a user equipment (UE), comprising:
receiving an indication of a configuration for synchronization of a communication link, wherein the configuration indicates a plurality of component carriers and respective priorities associated with the plurality of component carriers for the synchronization;
receiving a plurality of synchronization signals via at least a subset of the plurality of component carriers; and
synchronizing with a wireless device associated with a first component carrier of the plurality of component carriers, wherein the first component carrier of the plurality of component carriers for the synchronizing with the wireless device is selected based at least in part on the respective priorities associated with the plurality of component carriers.
